(19) United States
(12) Patent Application Publication
(10) Pub. No.: US 2014/0233919 A1
(43) Pub. Date: Aug. 21, 2014

(54) Memory Preservation and Life Story Generation System and Method

(71) Applicant: Treasured Stores, LLC, Baltimore, MD (US)

(72) Inventor: Colleen Sabatino, Towson, MD (US)

(21) Appl. No.: 14/183,520

(22) Filed: Feb. 18, 2014

Related U.S. Application Data
(60) Provisional application No. 61/765,850, filed on Feb. 18, 2013.

(51) Int. Cl. G11B 27/02

(52) U.S. Cl. CPC G11B 27/02
USPC 386/285

(57) ABSTRACT

Methods and systems for content management are disclosed. An example method can comprise a server receiving a plurality of content items. The content the plurality of content items can be associated with a theme. The computing device can process the received plurality of content items in accordance with at least one view, and can transmit the processed plurality of content items.

### CROSS REFERENCE TO RELATED PATENT APPLICATION

This application claims priority to U.S. Provisional Application No. 61/765,850 filed Feb. 18, 2013 herein incorporated by reference in its entirety.

### BACKGROUND

Online sharing of digital photos, audio recordings, videos, and documents can be achieved through commercial websites such as YouTube, FaceBook, Shutterfly, and Flickr, which can offer end users the ability to upload, share, and store media content secured with a username and password. However, there is a need to provide a more sophisticated content management system that enables users to record life events and attach such recordings to media in the form of stories that are emotionally and mentally stimulating for the users and those that access and share the stories.

### SUMMARY

It is to be understood that both the following general description and the following detailed description are exemplary and explanatory only and are not restrictive. Provided are methods and systems for content management. An example method can comprise a computing device (e.g., server) receiving a plurality of content items from one or more user devices. The plurality of content items can be associated with a theme. The computing device can process the received plurality of content items in accordance with at least one view, and transmit the processed plurality of processed content items.

In an aspect, a method for content management can comprise receiving a plurality of first content items, wherein the plurality of first content items are associated with a theme, and wherein the plurality of first content items comprise one or more images and one or more narrations. Using a computing device, the received plurality of first content items can be arranged into a plurality of sequential scenes relating to the theme, wherein one or more sequential scenes of the plurality of sequential scenes comprises a scene image and a scene narration relating to the image. A plurality of second content items can be received, wherein the plurality of second content items are associated with the theme, and wherein the plurality of second content items comprise one or more images and one or more narrations. Using the computing device, the received plurality of second content items can be arranged with the plurality of sequential scenes to create a story. The story can be caused to be presented to a user such as via a website.

An example content management system can comprise a processor and a memory. The processor can be configured for receiving a plurality of content items, processing the received plurality of content items in accordance with at least one view, and transmitting the processed plurality of content items. The memory can be configured for storing the received plurality of content items, and storing the processed plurality of content items.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate aspects and together with the description, serve to explain the principles of the methods and systems:

FIG. 1 illustrates an exemplary block diagram of basic components of a computing device such as a server;

FIG. 2 illustrates an exemplary display page from which the user can organize a representative life story having a set of content items corresponding to memory stimulation content generated from a questionnaire;

FIG. 3 illustrates an upload page from which an end user can begin a process of uploading content to a content management system;

FIG. 4 illustrates the memory stimulation questions from which the end user can begin to create a life story;

FIG. 5 illustrates a portion of the display by which a user can add supplemental content to existing content from a questionnaire generated by a user;

FIG. 6 illustrates an exemplary site infrastructure of a computing device such as a server;

FIG. 7 illustrates story components are joined through scenes;

FIG. 8 illustrates example story templates as a starting point for end users;

FIG. 9 illustrates exemplary components of a content management system;

FIG. 10 illustrates an example story with a plurality of scenes;

FIG. 11 illustrates the components and functions of a story in a content management system;

FIG. 12 illustrates a browsing user interface (UI) for finding stories or for organizing stories;

FIG. 13 illustrates a high level process for adding scenes to a story;

FIG. 14 illustrates screen showing adding media, story links, and web URLs to a scene;

FIG. 15 illustrates a user home page to present a plurality of life stories;

FIG. 16 illustrates the ability to view life stories page in a chronological view as well as in the masonry view;

FIG. 17 is an example of a user's landing page when the user select the hamburger icon in the top left corner the user's account profile drops down onto a screen;

FIG. 18 illustrates a user's ability to create a life stories page for the user himself as well as create life stories pages for others;

FIG. 19 illustrate a content management system can have the ability to create new communities, edit existing communities a user owns, contribute to a community, and/or follow a community;

FIG. 20 represents an exemplary community page;

FIG. 21 illustrates the drop down that appears when the hamburger icon is selected in the top left corner of a community page;

FIG. 22 illustrates what a user can see when viewing a community page owned by another user;

FIG. 23 illustrates what a user can see when viewing an individual life stories page owned by another user;

FIG. 24 illustrates what a user can see when viewing a public community page;

FIG. 25 illustrates the method for creating a narrated story;

FIG. 26 illustrates exemplary features that prompt a user to tell a story using memory stimulation questionnaires;

FIG. 27 illustrates a story page created and ready to be published;

FIG. 28 illustrates a published story page;

FIG. 29 illustrates what the story looks like when viewers (e.g., other users) view a story that is not their own;

FIG. 30 illustrates an exemplary page that appears when a user selects the “notifications” icon;

FIG. 31 illustrates an exemplary media library;

FIG. 32 illustrates an exemplary page that demonstrates a media library when a specific photo has been narrated;

FIG. 33 illustrates an exemplary computer device;

FIG. 34 illustrates an exemplary method;

FIG. 35 illustrates an exemplary method; and

FIG. 36 illustrates an exemplary method.

### DETAILED DESCRIPTION

Before the present methods and systems are disclosed and described, it is to be understood that the methods and systems are not limited to specific methods, specific components, or to particular configurations. It is also to be understood that the terminology used herein is for the purpose of describing particular aspects only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

The present methods and systems may be understood more readily by reference to the following detailed description of preferred aspects and the Examples included therein and to the Figures and their previous and following description.

As will be appreciated by one skilled in the art, the methods and systems may take the form of an entirely hardware aspect, an entirely software aspect, or an aspect combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Aspects of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure provides a content management system. As an example, an online application and user device application can enable an end user to provide a plurality of content items which can be captured through audio, video and text, metadata associated with a theme (e.g., a life story, a sequence of events, sub-parts of a single event). As an example, the theme can be pre-determined or selected by a user. The plurality of content items can be organized, published, shared, and stored to create a user-generated life story. In an aspect, the disclosed content management system can enable end-users to control over how an video-based, audio-based, and text-based content items in the course of their lifespan can be processed, displayed, and integrated with other media to create a customized audio and visual life story.

In an aspect, an end user can navigate to a website and use an application on his user device to upload a plurality of content items. The plurality of content items can be associated with a theme (e.g., a life story). The plurality of content items can be processed and stored in a memory of content management system. In one aspect, the processed plurality of content items can be displayed via a web page, such as a collection of narrated photos, documents, audios, and videos that are brought together by a template that can be shared by the end user. As such, a life story can be available from a website (e.g., a specific URL) that may be public, semi-public, or private, depending on the end users account preferences. In an aspect, the disclosed content management system can also allows multiple users, for example, family members and friends of the end user to contribute additional content items to the end user's life story if the user gives them permission to do so. In another aspect, the disclosed content management system can allow searchable dialogue technology to be used to find words or phrases which are spoken in recorded media streams.

In one aspect, the content management system can be made available from a website, and an end user can navigate to the website via a web a browser, upload a plurality of content items to the website via a user device (e.g., computer, smartphone, tablet, etc.). As an example, a user can select a content item and record a story. As another example, a user can select from a list of prepopulated and memory stimulation questions, and answer the questions using an embedded recording device as an audio input. In an aspect, recorded audio content can be converted to text and translated to different languages. The user can assign a plurality of content items to pre-existing corresponding memory stimulation questions or titles. In response, a server can be configured to take unstructured plurality content items, and provide a view (e.g., sequential view, chronological view, plot driven view, masonry view) for a theme (e.g., life story) based on the memory stimulation questions and titles. As an example, the view can be pre-determined or selected by a user. The view can be exported to the web browser and displayed as a web page.

In an aspect, the user may organize the content items by assigning terms to the plurality of content items, such that the plurality of content items can be searched on using one or more tagging tools. When the end user is satisfied with the materials that have been uploaded and data they have created using memory stimulation questionnaires, the user can select a publishing option. In an aspect, the end user can publish all, parts, or none of their story to all, some, or no one. The tagging of the plurality of content items can allow user to determine what is visible to whom and the publishing options can allow for a variety of sharing options. A user can share a story via email invite, share a story to others that can contribute audio recordings to the story, and publish to a website such as ancestry.com or Facebook. The website may also include the ability to produce the end user's story as a DVD, e-Book, or some other type of product.

Therefore, the disclosed content management system can enable user to control over how a life story can be created, preserved, and transferred. The content management system can also make it scalable to large numbers of end users. In an aspect, the content management system can put new content items into a respective user's life story without requiring any action from the user. In one aspect, the user can transmit a plurality of content items stored on a user device (e.g., smartphone, tablet) to a content management system. The content management system can copy and store the plurality of content items based on an associated life history timeline reference, description or key word, and the like. Therefore, creating a life story can be accomplished with no other tools necessary than a user device such as a smartphone, tablet, and/or a computer with internet.

In an aspect, the plurality of content items comprises one or more of video content, audio content, text, and metadata. As an example, metadata can comprise date, time, and location information associated with the content items. Specifically, metadata can comprise tagged information such as date, time and/or location when a content item is acquired, uploaded, updated, and the like. In an aspect, the audio content can comprises narrations or dialogues. In an aspect, the video content can comprise video clips, images, and/or photographs.

In an aspect, the content management system can process the plurality of content items in accordance with at least one view. As an example, the at least one view can comprise a sequential view, chronological view, plot driven view, or masonry view.

In an aspect, the plurality of content items can be associated with a theme. The theme can be a personal life story. The theme can comprise a plurality of scenes. In this scenario, the plurality of content items can be grouped into the plurality of scenes. As an example, the plurality of scenes can be organized according to an event in a story. As another example, the plurality of scenes can be organized according to a character (e.g., person) in a story.

The content management can process the plurality of content items, and the processed plurality of content items can be presented via an interface such as a website. The interface can be public, semi-public, and private. A user can access the interface by providing user account information (e.g., user identifier, password, etc.). An owner of a theme (e.g., story) can authorize one or more of a plurality of users to modify the content items associated with the theme (e.g., story).

In an aspect, the plurality of content items can comprise raw objects such as individual photographs as well as authored objects that combine multiple forms of content items into a life story. In one aspect, searchable dialogue technology can be used to finds words or phrases which are spoken in either live or recorded content items. Users can easily search their narrated stories and others in the system to find stories they want to hear. In one aspect, all content items can be tagged so that each content item can be assigned key words or descriptions that can be used to search for items later.

In an aspect, the content management system can allow a user to navigate through content items that has been uploaded into an account associated with the user. As an example, a first tab can display all the content items that have been stored in a user account on the content management system. A second tab can display a plurality of prepopulated memory stimulation questions that have been answered by the user and access to a list of questions yet to be addressed.

In one aspect, a user can create an audio recording for a digital photo by taking a photo from via a user device (e.g., smartphone, tablet, etc.), and record audio associated with the photo via the user device. Thus, a user can narrate his photos or documents.

A user can choose to have his/her life story made public. In an aspect, the user can receive comments from those who view their life story. For example, if a viewer is offered contributor status, the viewer can contribute a plurality of content items (e.g., audio, video, text, etc.), thereby making the user's life story a collaborative story.

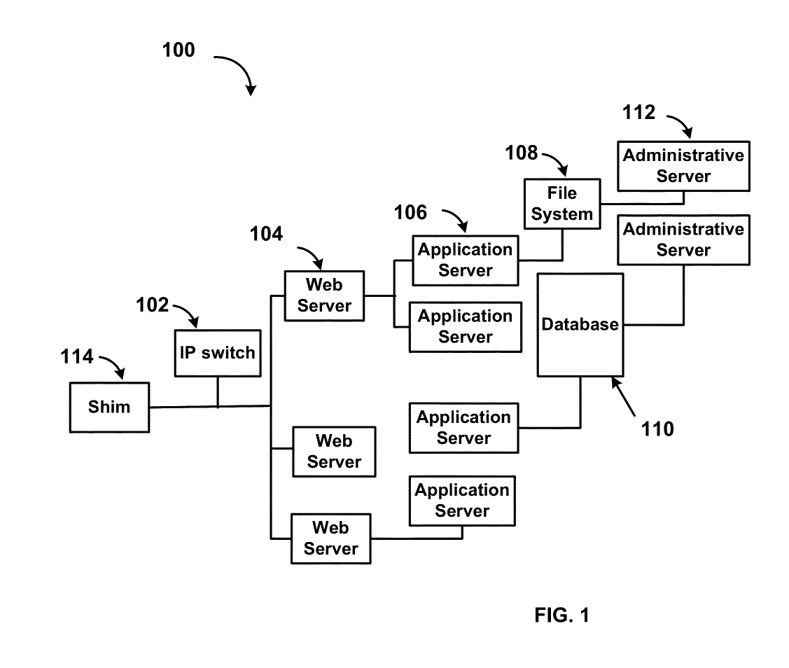

FIG. 1 illustrates exemplary block diagram of basic components of a computing device such as a server in the disclosed content management system. The architecture can implemented in or across one or more internet accessible data centers as a website together with associated applications running behind the site.

End users can operate via user devices such as computers, smartphones, and tablets that have internet access. As an example, an end user can operate via a web browser that is compatible with, for example, Extensible Hyper Text Markup Language (XHTML), Hyper Text Markup Language (HTML), and Extensible Markup Language (XML) or other languages. In an aspect, a plurality of content items can be transmitted between a user device and the server using, for example, Hyper Text Transfer Protocol (HTTP). A user can access a website by opening the browser to a URL (Universal Resource Locator) associated with a service provider domain. The user can be authenticated to the site by entry of a username and password. The connection between a user device and the server may be private via SSL (Secure Sockets Layer).

As seen in FIG. 1, the “server side” of the system 100 can comprise an IP (Internet Protocol) Switch 102, a set of web servers 104, a set of application servers 106, a file system 108, a database 110, and one or more administrative servers 112. As an example, the web servers 104 can comprise an application server software that executes on a commodity machine (e.g., an Intel-based processor running Linux, for example, any server with an Intel Xeon or Itanium processor). The set of application servers 106, for example, can comprise a server with an Intel Xeon or Itanium processor executes the image handling and transformation applications (including image layout and reflow). As another example, the file system 108 can be an application level distributed system that operates across a number of servers using an HTTP interface. The file system can be, for example, ZFS, and can be expandable for storage as necessary. The database 110 can be implemented using MySQL or any other convenient relational database management system. The administrator servers 112, for example, can comprise a server with an Intel Xeon or Itanium processor capable of handling back end processes that are used at the site or to otherwise facilitate the service. These back end processes, for example, can comprise user registration, billing and interoperability with third party sites and systems as may be required. In an aspect, the system 100 can also comprise a client a shim (e.g., side code) 114 that executes natively in a user browser or other rendering engine. The shim 114 can serve to a user device when a user accesses the website, but does not necessarily become resident on the user device.

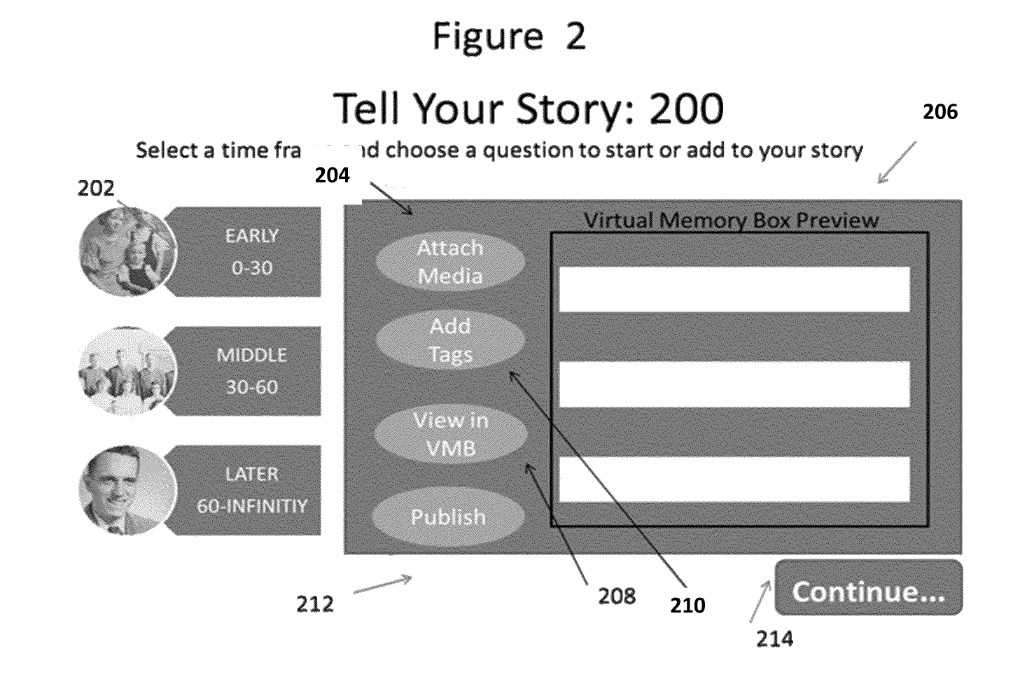

FIG. 2 illustrates an exemplary display page from which the user can organize a representative life story having a set of content items corresponding to memory stimulation content generated from a questionnaire. A plurality of tools can be used by an end users to upload a plurality of content items. Once a content item is uploaded to the content management system, an end user can identify what prepopulated or newly formed memory stimulation questions are best suited to the content item. Once identified, the end user attaches one or more suitable content item as answers to the question.

In FIG. 2, when the end user selects the “Tell Your Story” option 200. Options include a timeline section 202 that takes the user to a databank of memory stimulation questions, Uploading media items button 204 to access media items that have been selected from user's machine, a virtual memory box (VMB) viewer 206 for viewing the layout of the story in the template, which is a page that is linked to from a “View in VMB” button 208, an “Add Tags” button 210, and a “Publish” button 212 for setting share and privacy options for each element of the virtual memory box. Sharing options can comprise inviting another person to view the user's virtual memory box by email, obtaining the HTML to publish the story on the website or other site, sending the story to a third party site such as www.ancestry.com. Upon selecting a continue button 214 on page 200, a server can execute an initial layout algorithm which takes the unstructured set of materials identified by the user and in response, provides an initial layout for the story in the virtual memory box preview 206. Generally, the initial layout algorithm can take the received content items, and associated them with a set of memory stimulation questions. A template can be generated and an initial layout for the user's life story can be produced. The initial layout algorithm can take a set of content items (e.g., text, photos, video files, audio files, etc.) and produce a layout for a story. The layout for the story can be a template with square elements that hold items selected by a user. As an example, items can comprise photos, story content, text documents, or anything selected by the user. A template can comprise a fixed initial part and then a repeating part, which can be repeated as needed to fill the template using all the items that the user has selected for the story.

A reflow algorithm can be used when the end user changes (e.g., adds, deletes, modifies, updates) elements in his or her virtual memory box. The algorithm can be used to enforce one or more rules about the view template. These rules include, for example, that the view cannot have extra space, the items cannot overlap. The reflow algorithm can work in conjunction with the following attributes: collision and whitespace. A collision can occur when two items overlap. Whitespace can be collapsed if there is too much space or left where it is.

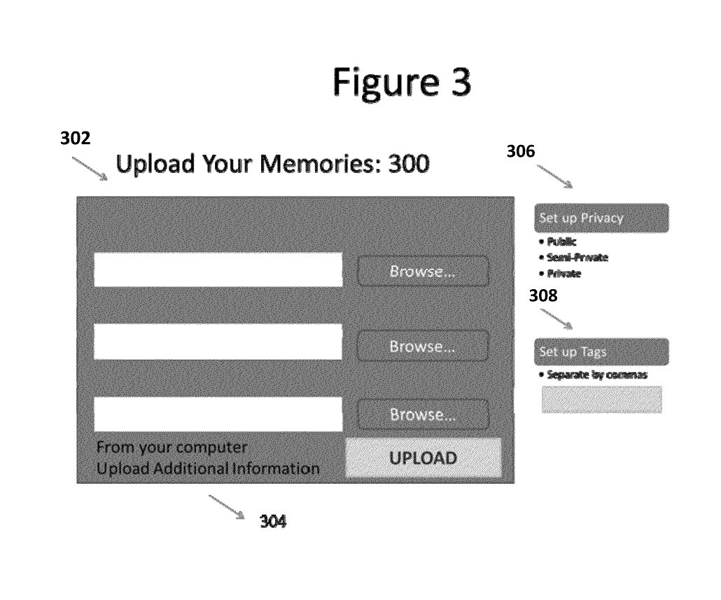

In FIG. 3, a page 300 can be displayed to provide the end user with a local file search and upload tool 302, as well as a navigation bar 304 from which the end user can select for download one or more content items. The page 300 can also comprise a display panel 306 through which the end user sets a “privacy” setting for public, authorized users, or private. The page 300 also comprise an input form 308 through which users can identify one or more tags for the story; the system uses these tags to identify the story to one or more search processes.

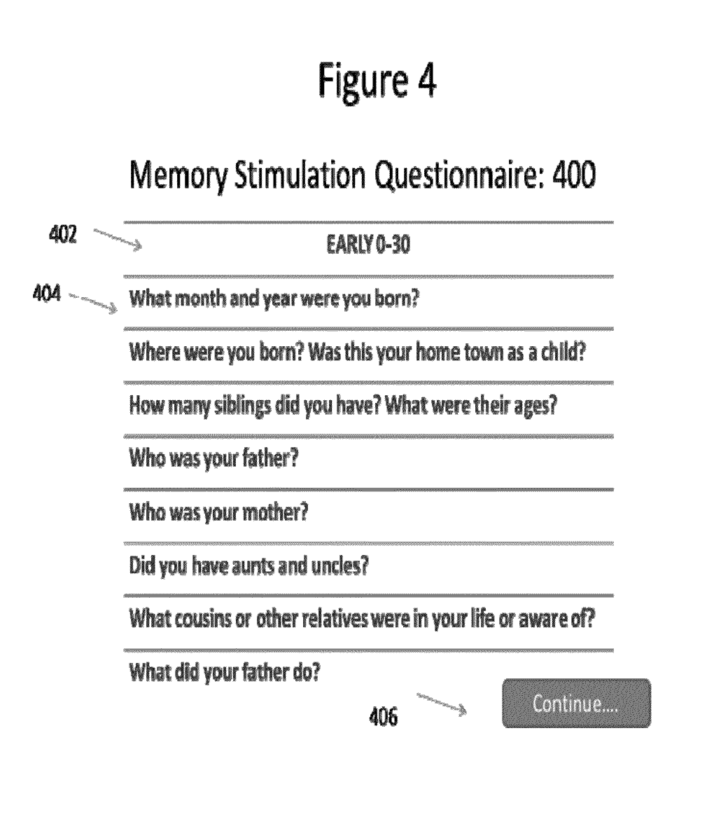

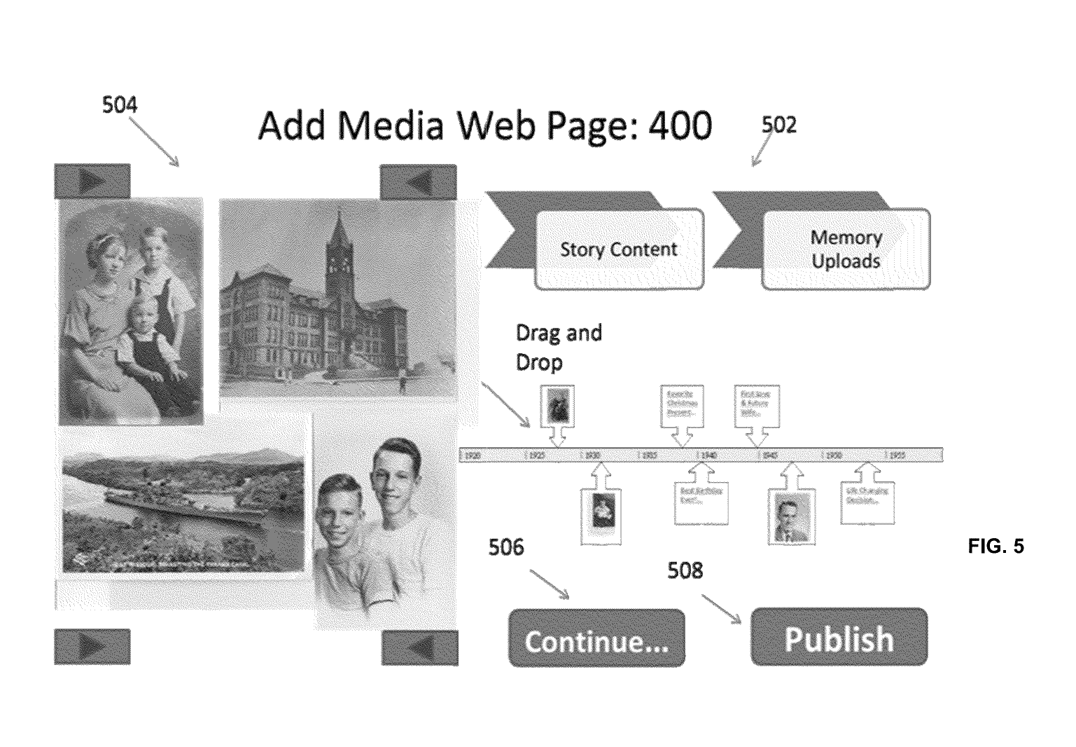

Once a plurality of content items are uploaded to the system, an end user begins the process of creating a visual story by navigating to make a “Story” and selecting a link to create a new story. As a result, a “Story” page can be displayed as illustrated in FIG. 4. FIG. 4 also illustrates a memory stimulation questionnaire page 400 that can be used to input and organize information into the system, which can be used to engage the end user in memory stimulation activities facilitated by the use of the questionnaires embedded within the system 400. Page 400 can comprise a first “Categories” section 402 that includes, for example, “early years” and which generates a list of questions 404 relating to the end user's life from birth to age 30. When a question is selected by the end user via their machine, a text box (not shown) can be created to allow the end user to input text that is then saved in association with one of the coordinating questions 404. After the end user has added the desired content, they select the “Continue” button 406 to proceed to an “Add Media Page” 500, as shown in FIG. 5.

FIG. 5 shows how the end user can then select which content items are to be included in what portion of their life story by dragging and dropping the selected items from the first section to the second. As can be seen in FIG. 5, page 500 includes a “choose Story Content” and “choose Memory Uploads” area 502, which includes a timeline. The user can then select which of content and media can be included in a given story, e.g., by dragging and dropping the selected media and content from a media section 504, which is a holding area for the content items, to the timeline in the “choose Story Content” and “choose Memory Uploads” area 502. After the content and media are selected and dragged from the holding area to the timeline, the user selects the continue button 506 to continue the process of creating their story. When the user is satisfied with the view and content of their story, he or she then selects a publishing option button 508, which can be achieved by having the user navigate to a Share page (not shown). From the share page the user can select a story publication option such as, for example, inviting others (e.g., via email) to view the story, sending the story to a third party site such as www.ancestry.com, selecting who can view the story, and selecting others who the user authorizes to contribute to the story.

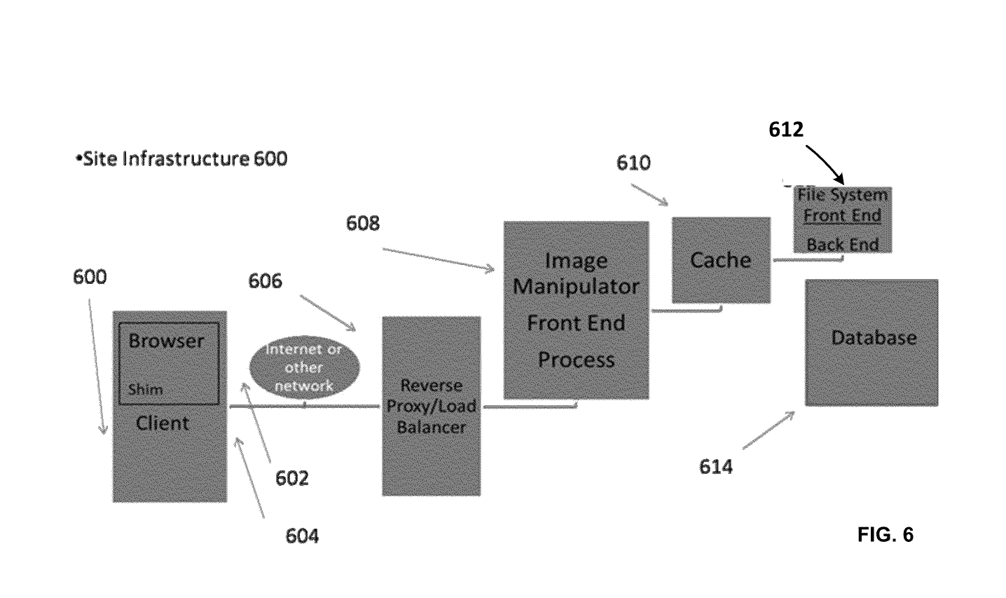

A Site Infrastructure 600 is illustrated in FIG. 6 to show both the client and the server side architecture of the site. A client device 600 running a browser 602 connects to the site over the internet. The browser includes a shim 604 to facilitate the client side operations. Incoming connections are received at a reverse proxy/load balancer 606 that provides a front end to an image transformation application engine 608. The image transformation application 608 is implemented as a pair of image manipulator front end (IMFE) processes which have a cache 610 associated with it. The IMFE is distinct from a file system 612 that provide access to a database 614 in which content items can be stored.

An aspect of the content management system can comprise at least one web server communicatively connected to a network system and adapted to send to and receive information from a user that is also communicatively connected to the network system. The system can further comprise at least one application server communicatively connected to each of the at least one web servers, and being communicatively connected to a database via a file system. The system still further can comprise at least one administrator server communicatively connected to the file system and/or database.

An aspect of the present method can comprise receiving a plurality of content items via a content management system. The content management system can store and process the received content items. For example, the content management system can store a user's life history information from birth to present day. The content management system can associate the content items and other information (e.g., history information) to generate a life history. The content management system can also associate tagged information with the content items. The content management system can also receive publishing guidelines for controlling access and modification rights to the content items.

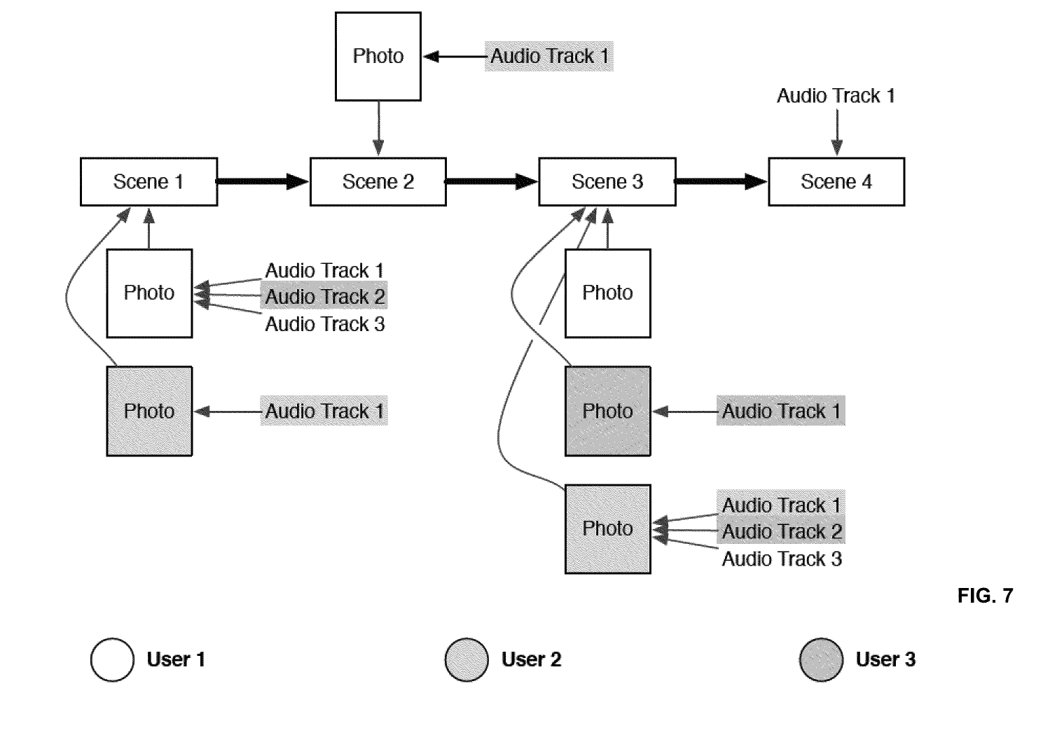

FIG. 7 illustrates story components joined through scenes. A plurality of content items can be grouped according to scenes. FIG. 7 also shows that story elements can be contributed by multiple users. As an example, the order of hierarchal relationships can be story scenes content items (e.g., video, audio, photo, text).

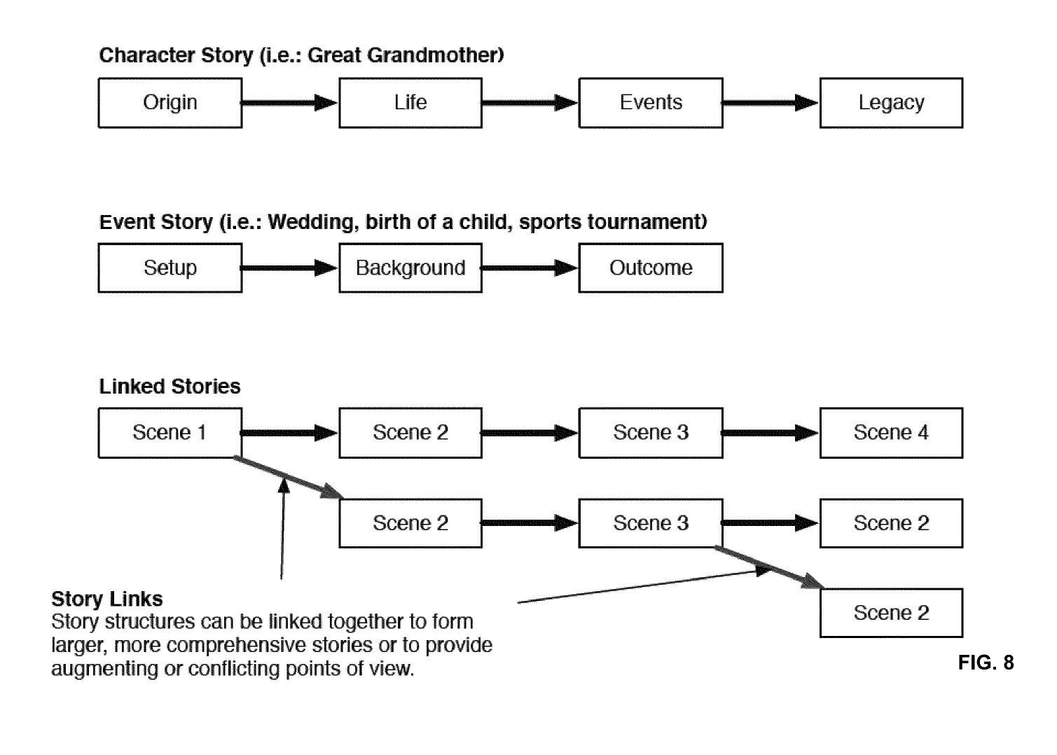

FIG. 8 illustrates example story templates as a starting point for end users. Story templates can be used to describe common story prototypes to allow users to tell the story of their great grandparent without having to layout the specific story scenes. As an example, a questionnaire can be in the form of a story template. End users can also contribute story templates to be used by other end users. There can be curated story templates via, for example, voted rankings.

Story links can provide a way for other end users to continue or augment the user's story. An entire family history can be told by several generations of the family by adding links to a user's particular family tree and providing the content for that branch of the story. Users may want to expand on an element of a story to tell more than the user had originally planned or had experience with.

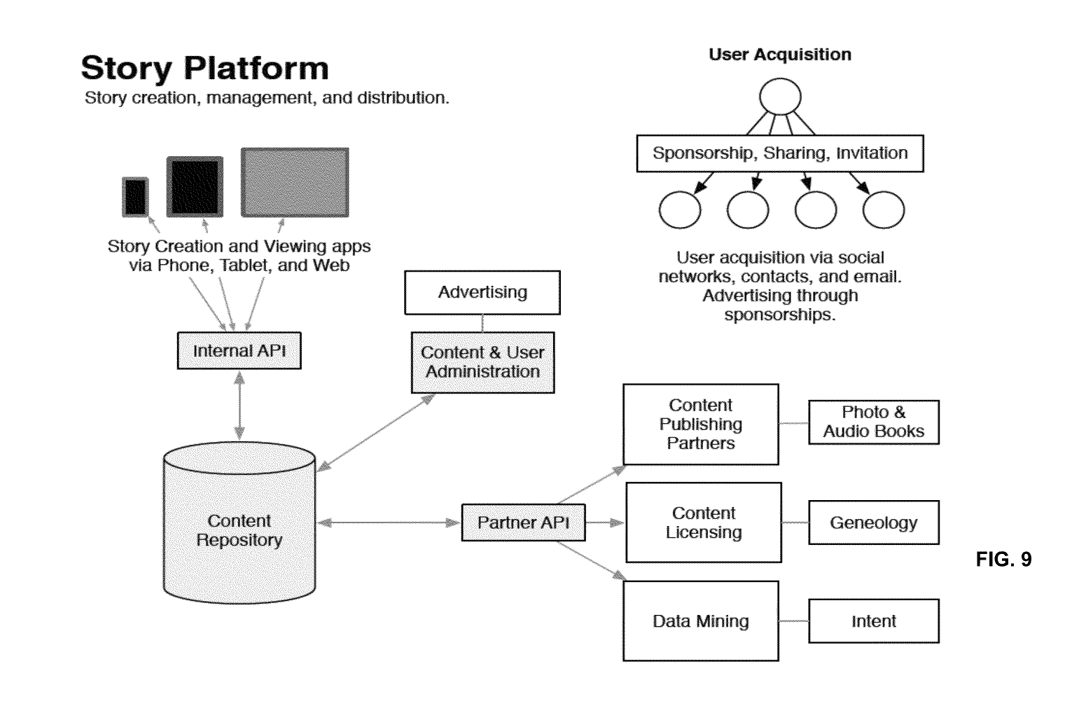

FIG. 9 illustrates exemplary components of a content management system. Story creation and viewing apps can be based on internal APIs which can drive the creation of content for the entire platform. End users can contribute and view stories and associated content items (e.g., photos, video, audio) through these primary apps. These would be the iPhone app, the iPad app, the website, etc.

The content would be administered through an internal app which would allow privileged users to configure story templates, review and flag content, curate content for browsing screens, provide user support, or whatever administrative functions were required to manage the platform.

A key workflow of the administration app would be the management of 3rd party access to content. Advertising could be configured (via ad & tracking links) or content rights could be defined to allow 3rd parties to re-purpose content. Some examples of how content can be re-used include printed audio books, content could be licensed to and leveraged by family history and genealogy services. Content could be mined for intent and interest data to be collected by marketers for research or advertising. User acquisition can occur through social media connections (sharing, invites) and through sponsoring communities.

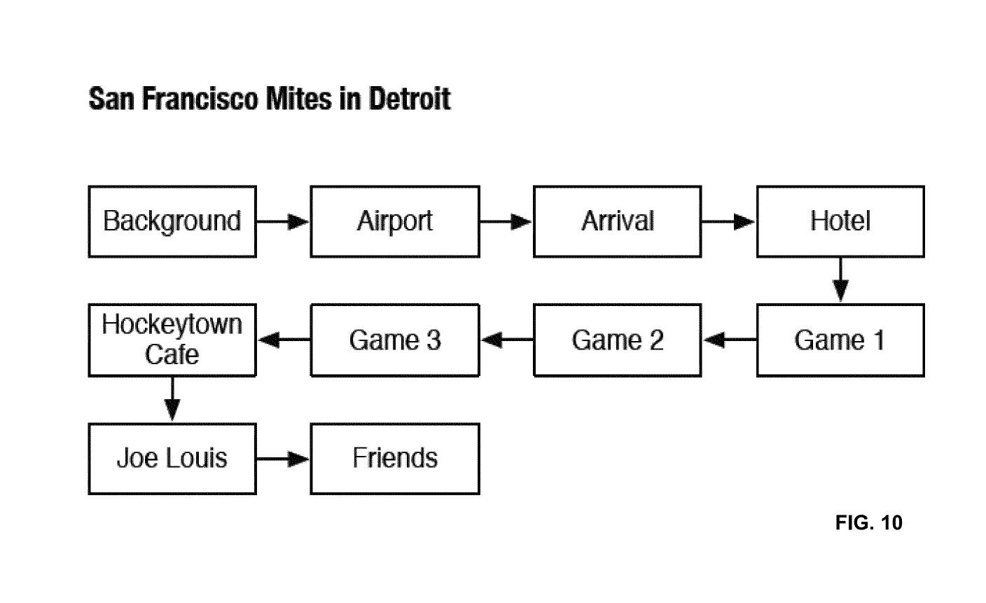

FIG. 10 illustrates an example story with a plurality of scenes. Each scene can be composed of photos and videos contributed by the providers. As an example, one or more scenes can comprise a scene image and a scene narrative associated with the scene image.

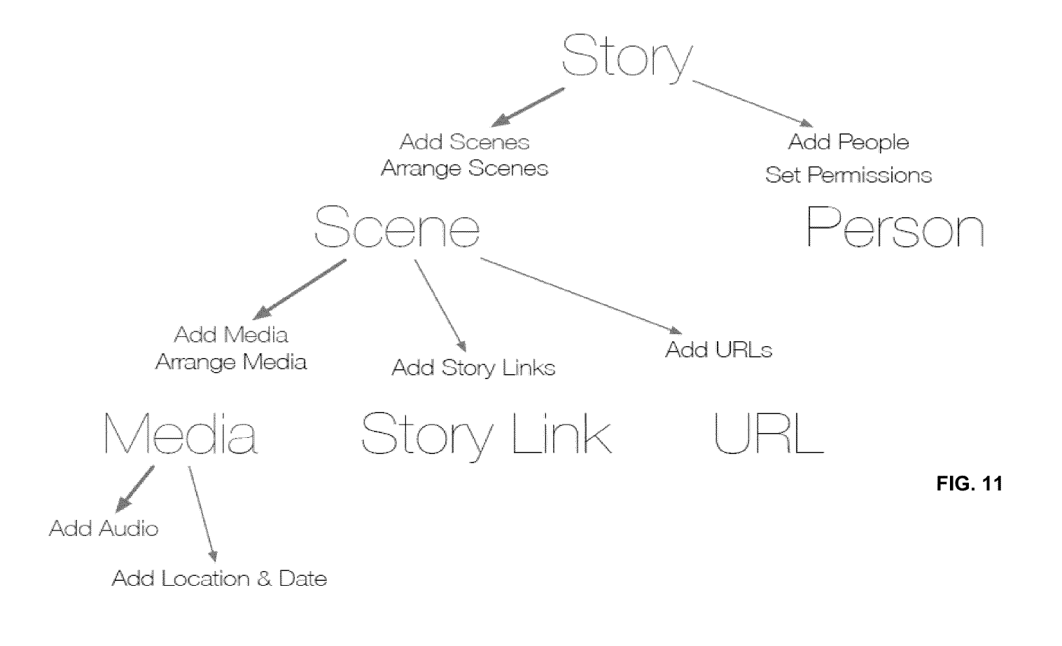

FIG. 11 illustrates the components and functions of a story in a content management system. A story can be composed of scenes and character. A scene can be composed of content items such as audio, photos, videos, and the like, story links, and URLs to external content.

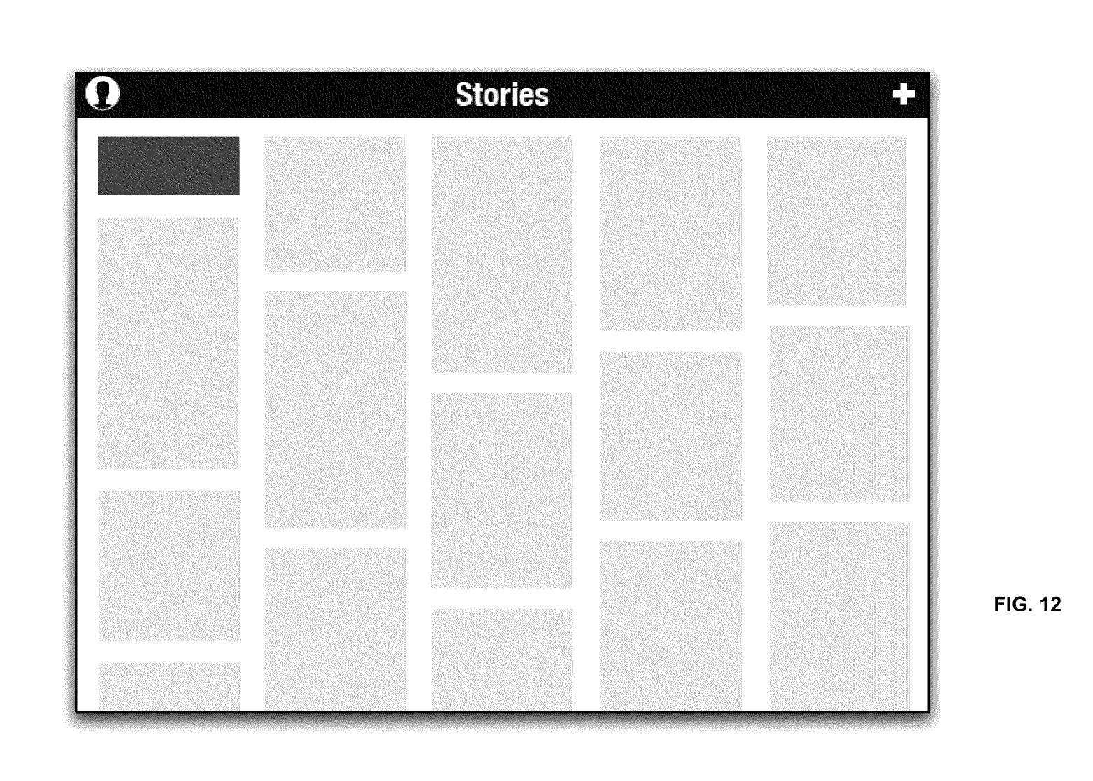

FIG. 12 illustrates a browsing user interface (UI) for finding stories and organizing stories. The UI can provide searching, filtering, and sorting functions for finding stories and organizing stories.

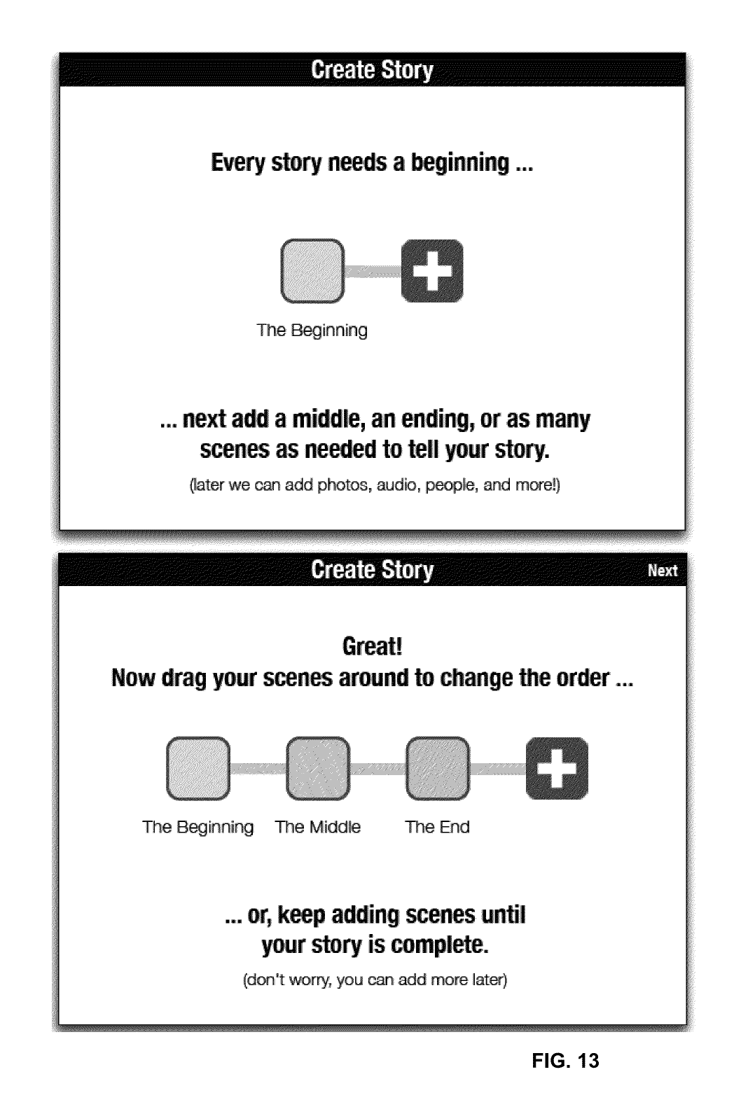

FIG. 13 illustrates a high level process for adding scenes to a story. A scene can be simply a title and container for users to contribute photos. A user interface (UI) can allow users to re-title scenes, rearrange theme, and re-edit the sequence.

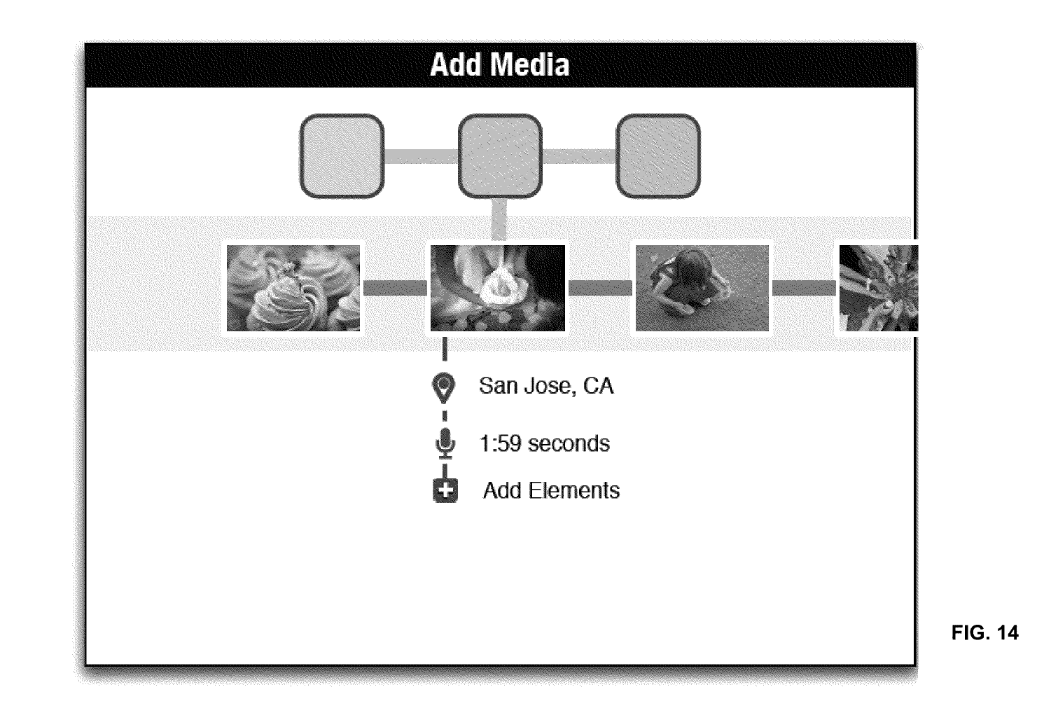

FIG. 14 illustrates screen showing adding media, story links, and web URLs to a scene. For example, after defining the scenes of a story, a user can contribute elements to a particular scene. This diagram shows that a scene can be comprised of a plurality of photos and how audio, location information, links, and the like, can be added to the plurality of photos.

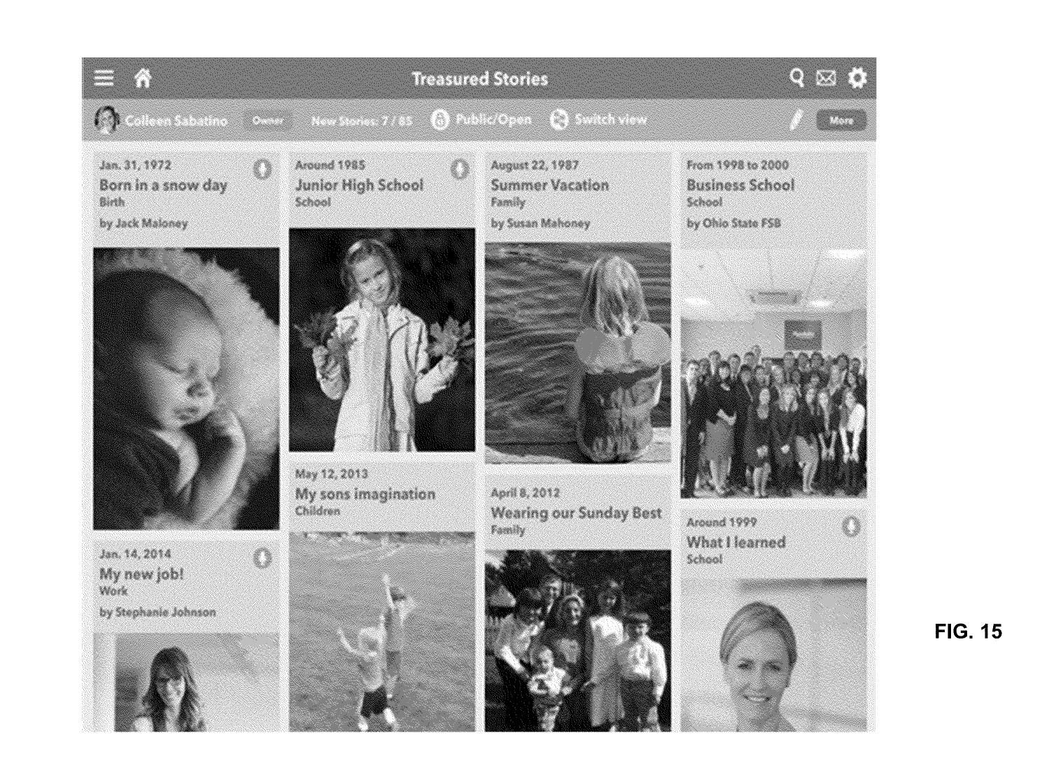

FIG. 15 illustrates a user home page to present a plurality of life stories. It can be seen that most recent stories can be displayed in a masonry view, which can dynamically expand or contract to fit a screen size that a user is using to view the user home page. In an aspect, the number of contributions contributed to a life story on the user home page since the user's last visit can be displayed. In an aspect, the number of story contributors for the user's life stories on the home page can be displayed. The plurality of life stories can be made public, private, or semi-private. A plurality of life stories can be displayed in chronological view from the date from which the story took place instead of date created by selecting the timeline view.

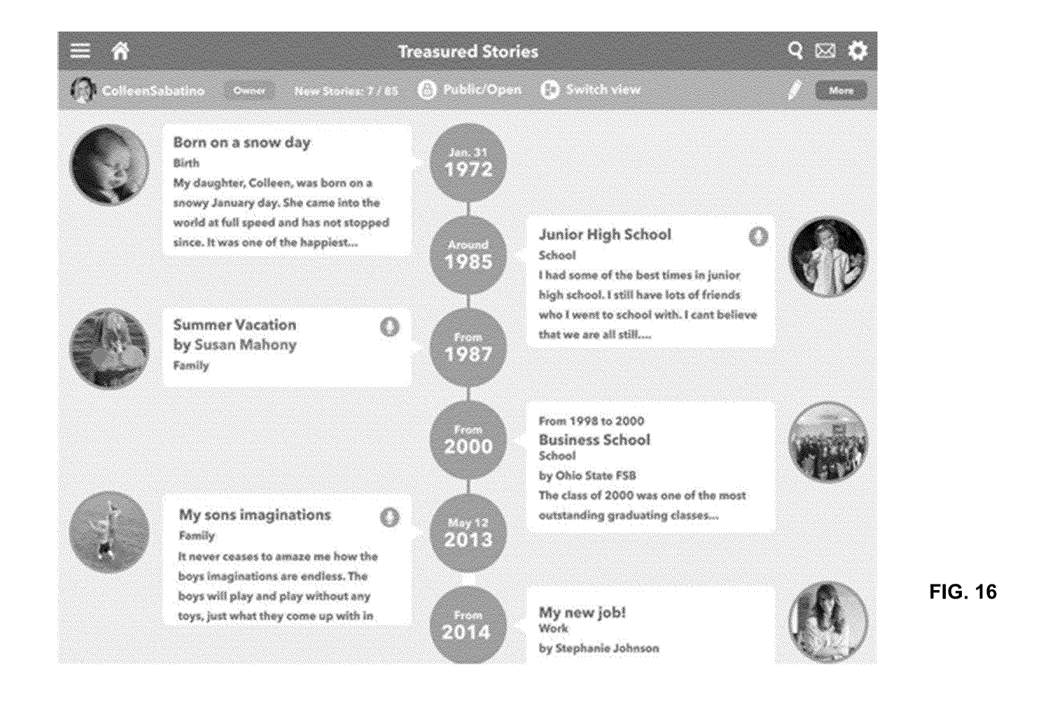

FIG. 16 illustrates the ability to view life stories page in a chronological view as well as in a masonry view. This view is available for both individual life story pages (biographies) and community pages which represent stories dedicated to a specific topic and contributed by a plurality of users.

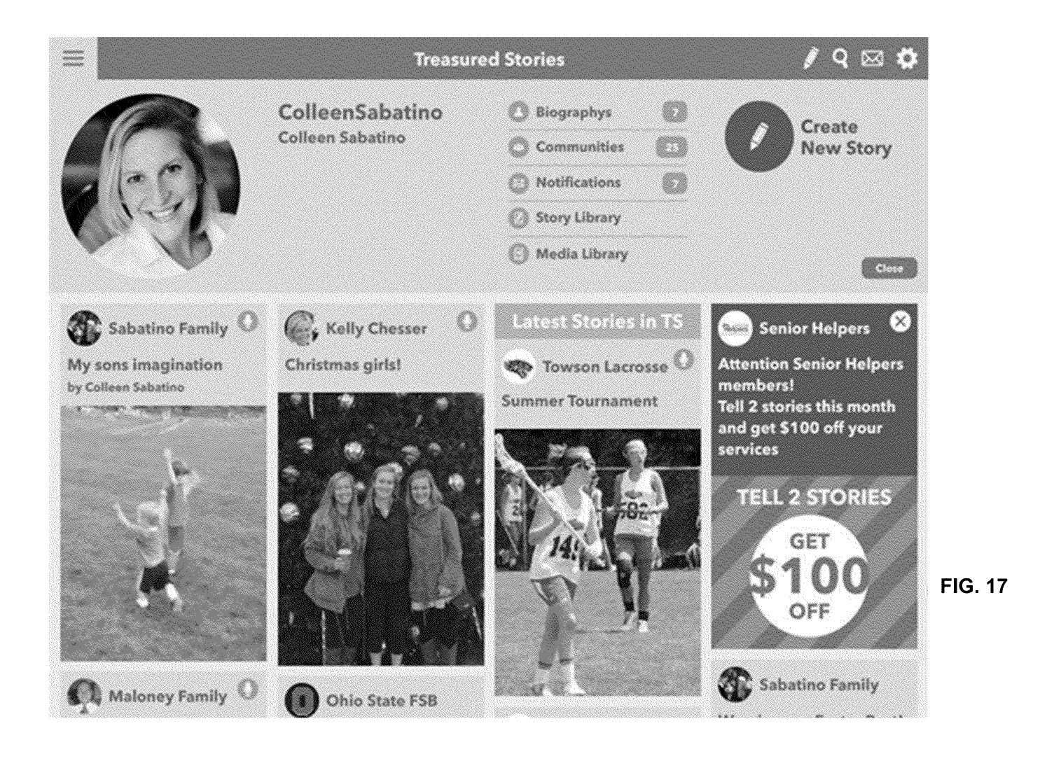

FIG. 17 is an example of a user's landing page when the user selects the hamburger icon in the top left corner the user's account profile. In an aspect, when logged in the user's account, the user can create a new story, access any of the biographies they own, follow, and contribute to. The user can access communities they own, follow, and contribute to. The user can access notifications, story library, and media library associated with the user.

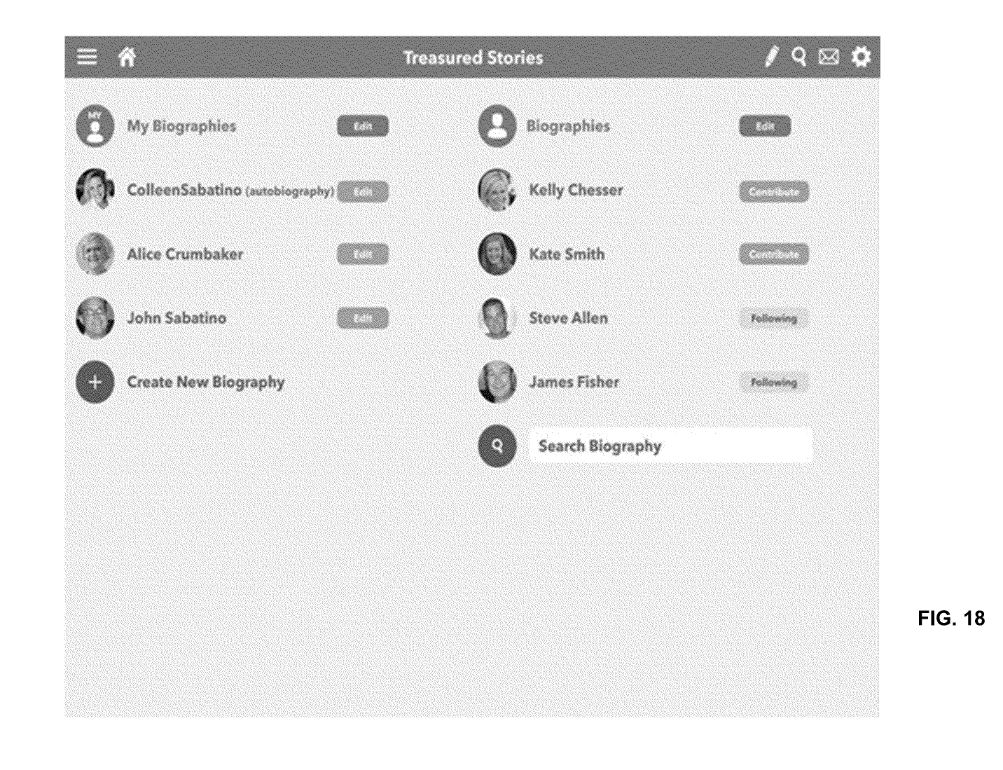

FIG. 18 illustrates a user's ability to create a life stories page for himself as well as create life stories pages for others. For example, a life stories page can comprise remembrance pages for loved ones by creating, sharing, and preserving their life stories. As another example, a life stories page can also be life story pages of the user's children, so that when they are old enough to take over their life story pages, the user (e.g., account owner) can transfer the life story page and the stories up to the point it was created and updated. FIG. 18 also illustrates the ability for a user to be able to contribute and/or follow other users' life story pages with their permission. When a life story pages a user follows or contributes is activated, the user is notified.

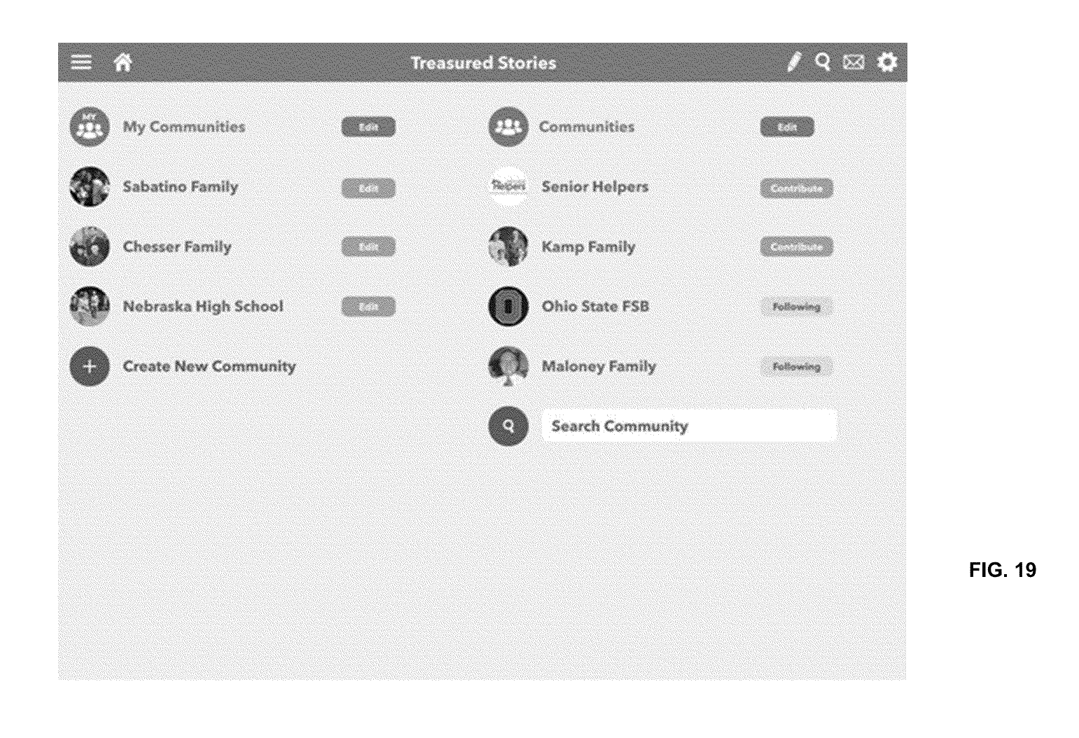

FIG. 19 illustrates that a content management system can have ability to create new communities, edit existing communities a user owns, contribute to a community, and/or follow a community. The purpose of communities is to provide a platform for multiple users to easily create, share, and preserve stories relating to a specific topic. While every story that a user creates and publishes can be automatically added to their personal life stories page, they can choose to create and/or join an existing community that lets the content management system post the story automatically to that community page based on how the story is tagged. A user can post a same story to multiple communities in addition to their personal life stories page. If a community is public, then users who join the community can have contributor status. If a community is private, then a user can get permission from a community owner to become a contributor.

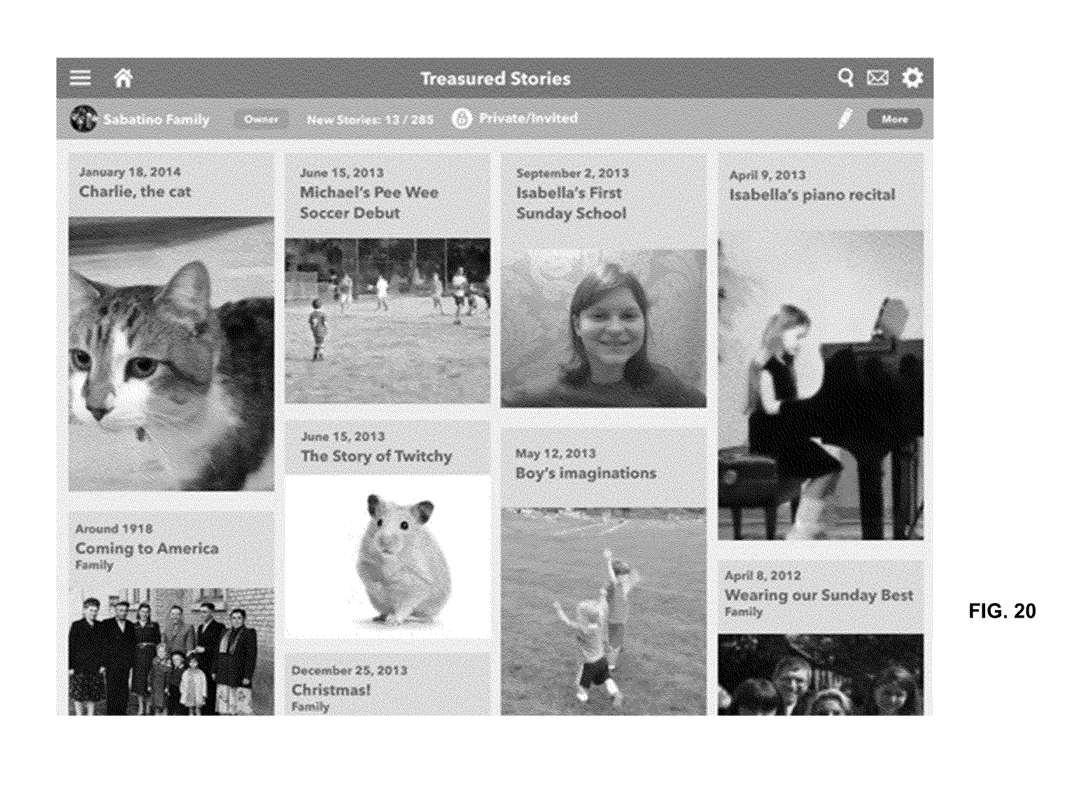

FIG. 20 illustrates an exemplary community page. As an example, the community page can be a family community page. It can look identical to an individual page, instead having multiple users contributing multiple stories about multiple people that constitute that community name. As an example, a biography page can have multiple contributes with multiple stories but they can only be about that one person for whom that life stories page was created. The community page can allow multiple users to contribute multiple stories about multiple people and events that are related to the topic for which that community was created.

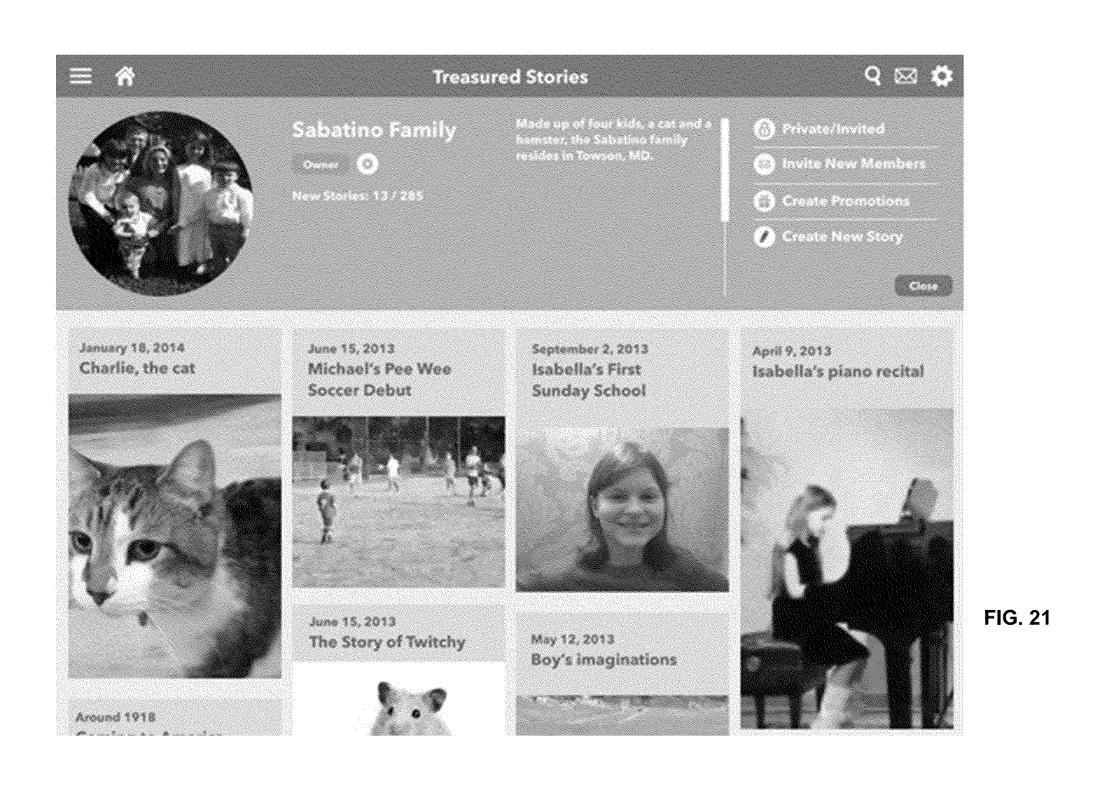

FIG. 21 illustrates the drop down that appears when a hamburger icon is selected in the top left corner of a community page. In an aspect, a user can see details and read descriptions about a community. An owner of the community page can proactively invite other members to join/contribute to the community. The invited members can create a story from this page. The contribution can be added to the community page and their respective personal life stories page. The owner can also make announcements or offer promotions to other members of the community. The owner can also see the number of story contributions have been added since his last visit and the number of total story contributions within the community.

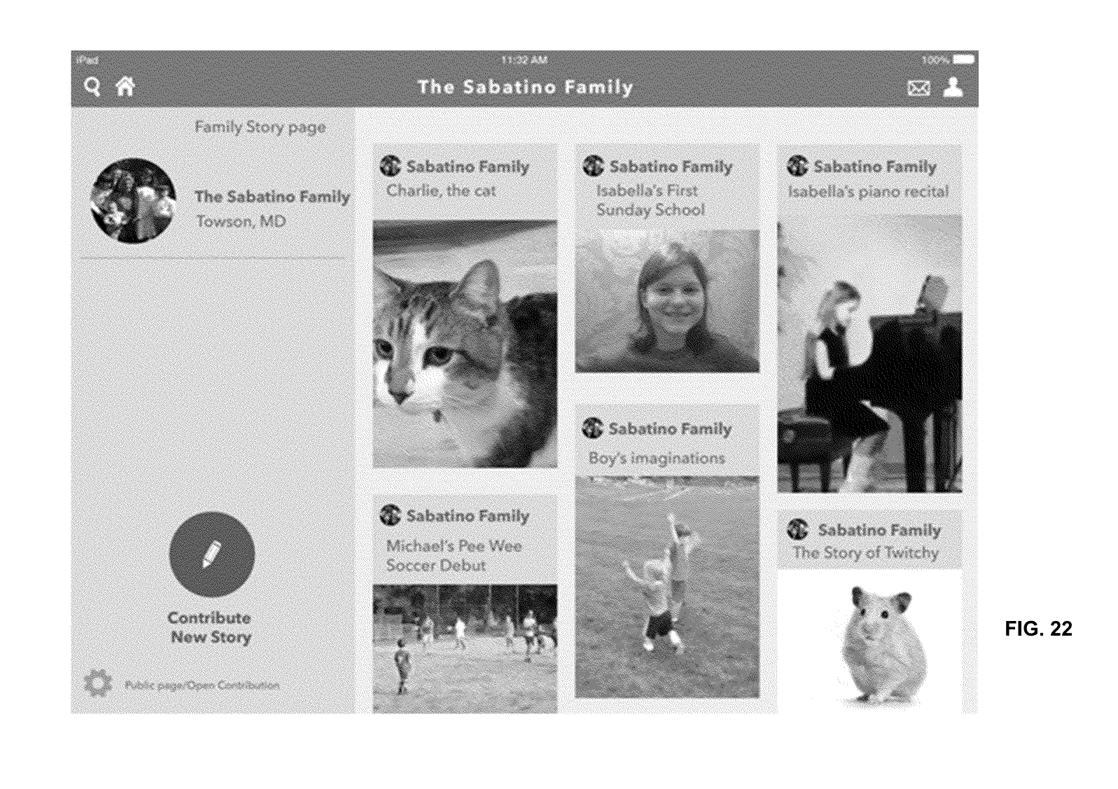

FIG. 22 illustrates what a user can see when viewing a community page owned by another user. In an aspect, the user has contributor status and is encouraged to contribute a story to the community page.

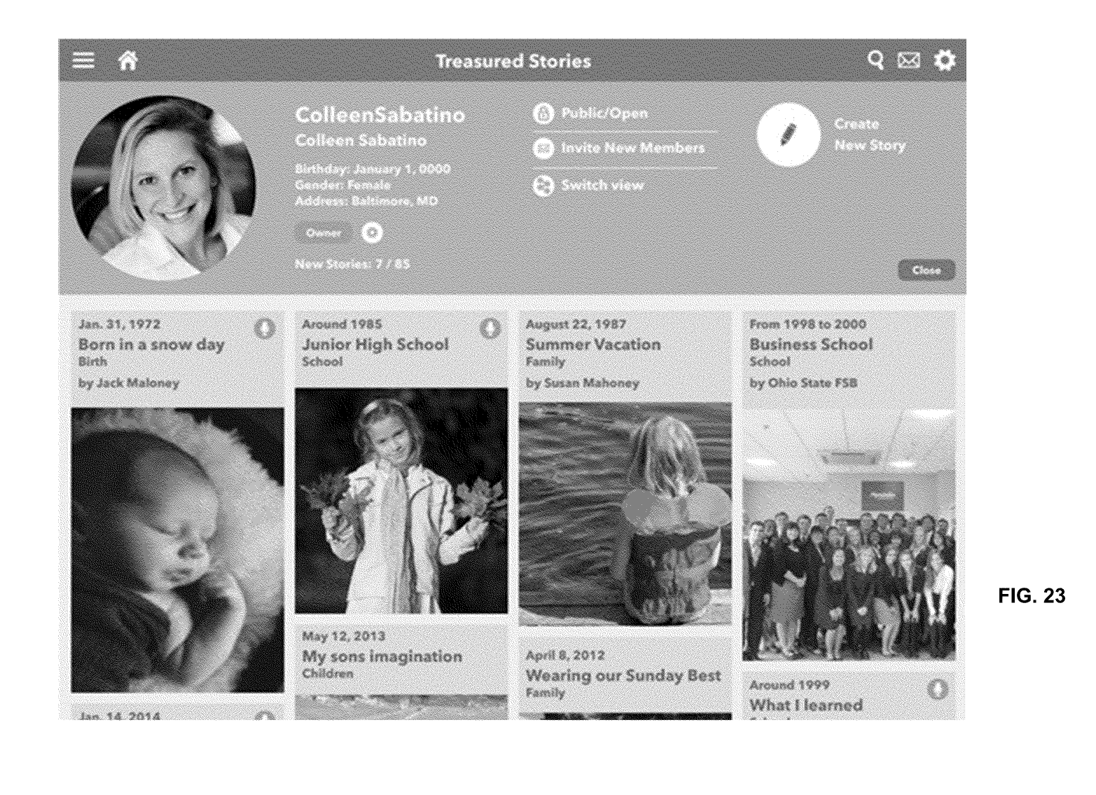

FIG. 23 illustrates what a user can see when viewing an individual life stories page owned by another user. As a public page, a user can visit a story page are encouraged to create a story and invite new members to see the life stories page. The number of stories contributed since last visit and the total number of stories can be displayed.

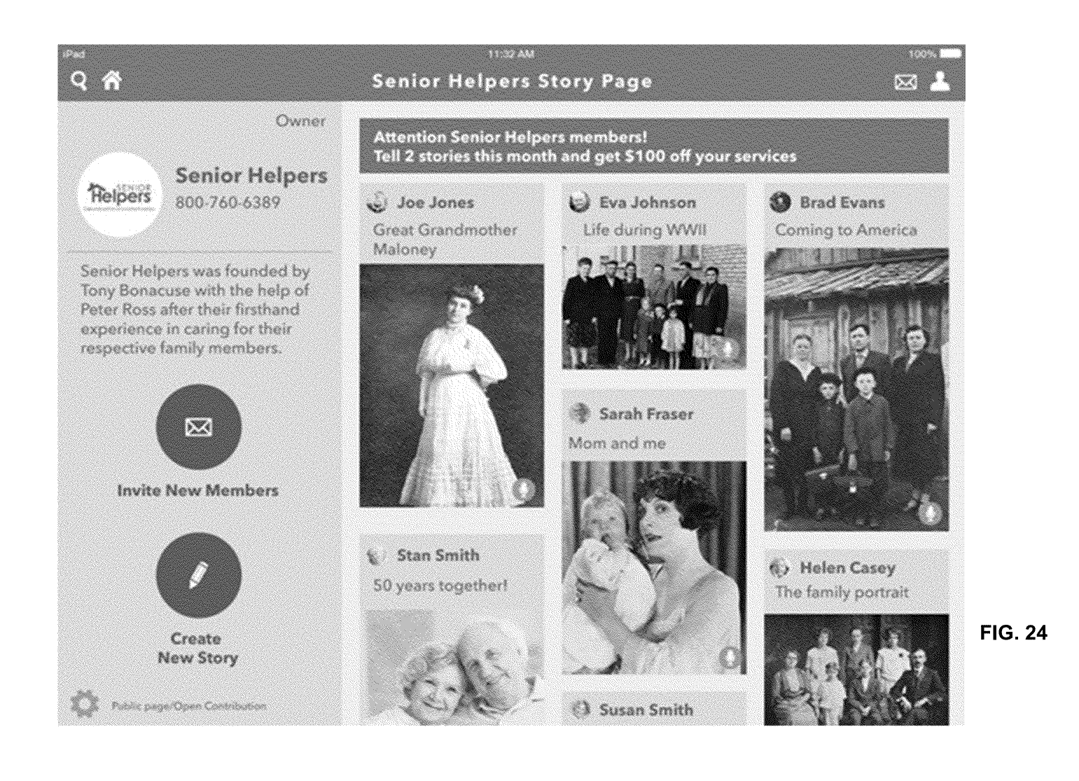

FIG. 24 illustrates what a user can see when viewing a public community page. On the left of the communication page can comprise information about the community and icons that encourage the user to create new stories within this community and invite people to join this community. Across the top of the communication page can comprise promotions that a community owner creates. The masonry view can comprise a listing of the stories that have been contributed to the community by its members.

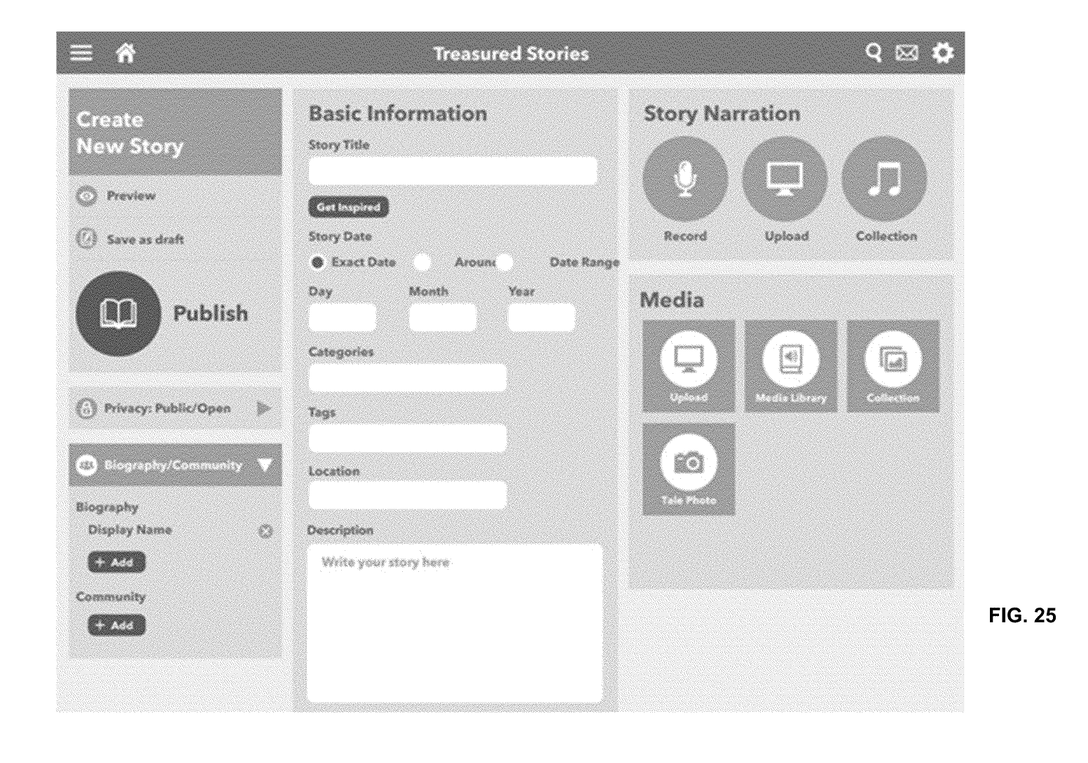

FIG. 25 illustrates the method for creating a narrated story. Once a user selects to create a story, the user can be brought to this screen. The user can select to record his story via an audio input. The user can also upload an existing audio file this screen. The user can choose to add music tracks as background music to his story. The user can also take a photo and add a recording directly to the photo. The user can select a content item (e.g., photo) from his user device (e.g., phone, computer) and upload it to the content management system, and attach a narration to the content item. As an example, the user can select one or more photos from his media library and record narrations to the photos. As another example, the user can select from pre-populated photos from a photo collection. The user can determine if a created story is public or private, and the user can choose a bio created for a story, and communities they would like to share the story.

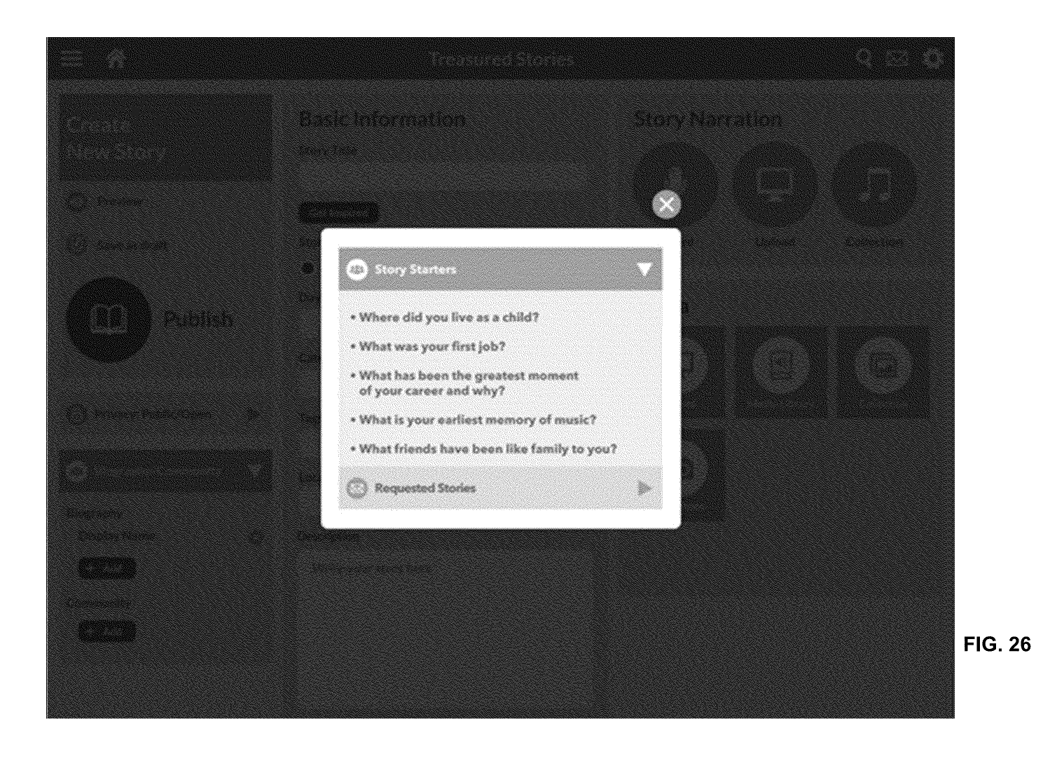

FIG. 26 illustrates exemplary features that prompt a user to tell a story using memory stimulation questionnaires. Once a user selects a question, it can pre-populate the story title in the form of a statement, and the user can user an audio input device (e.g., a microphone) to start recording their story.

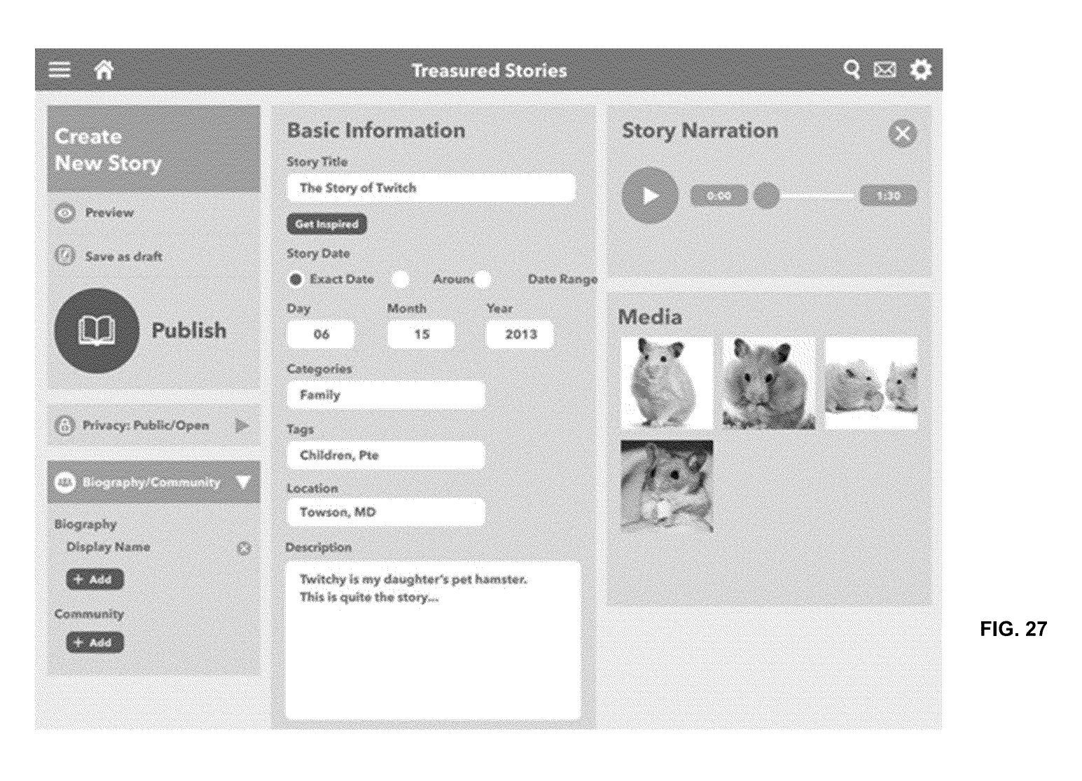

FIG. 27 illustrates a story page created and ready to be published. Before a story page is published, a user can modify content items associated in the story page. In an aspect, a user can add text to the story page, and identify information in the story page such as tags, dates, and locations.

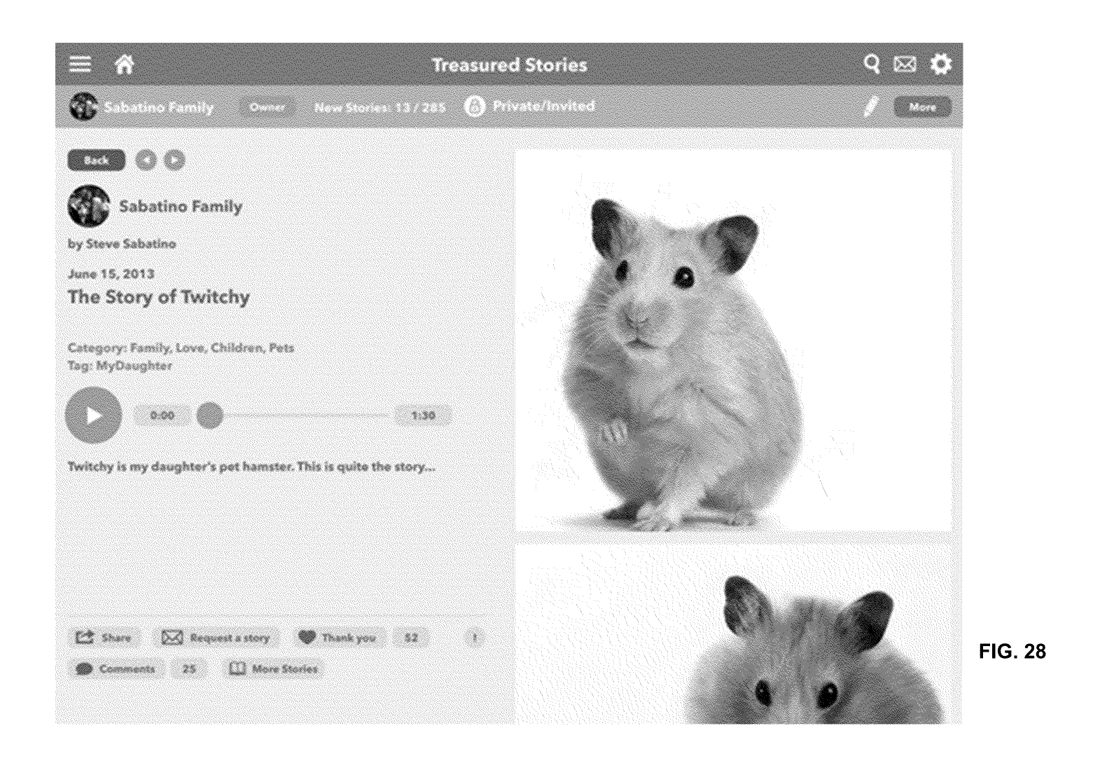

FIG. 28 illustrates a published story page.

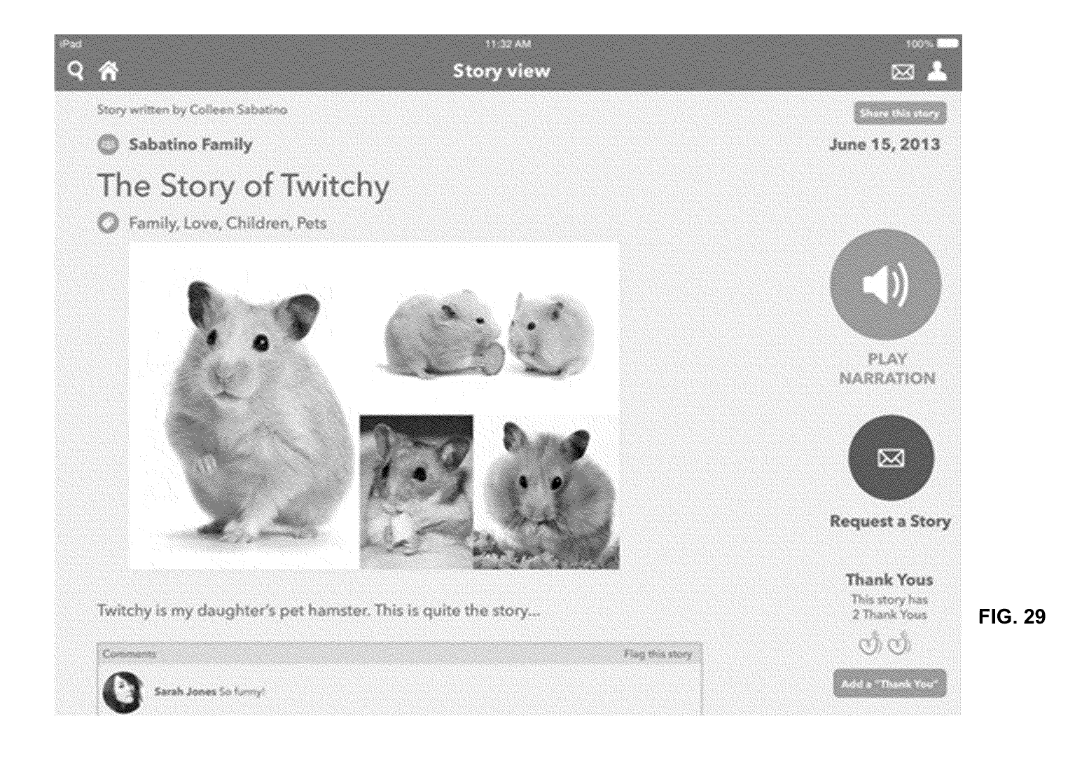

FIG. 29 illustrates what the story looks like when viewers (e.g., other users) view a story that is not their own. In an aspect, viewers can be prompted to play the story. The viewers can be prompted to request a story from a user that comes to mind for them. The viewers can comment on the story. If they were given contributor status they can add narration (not shown). Viewer can also prompted to share the story.

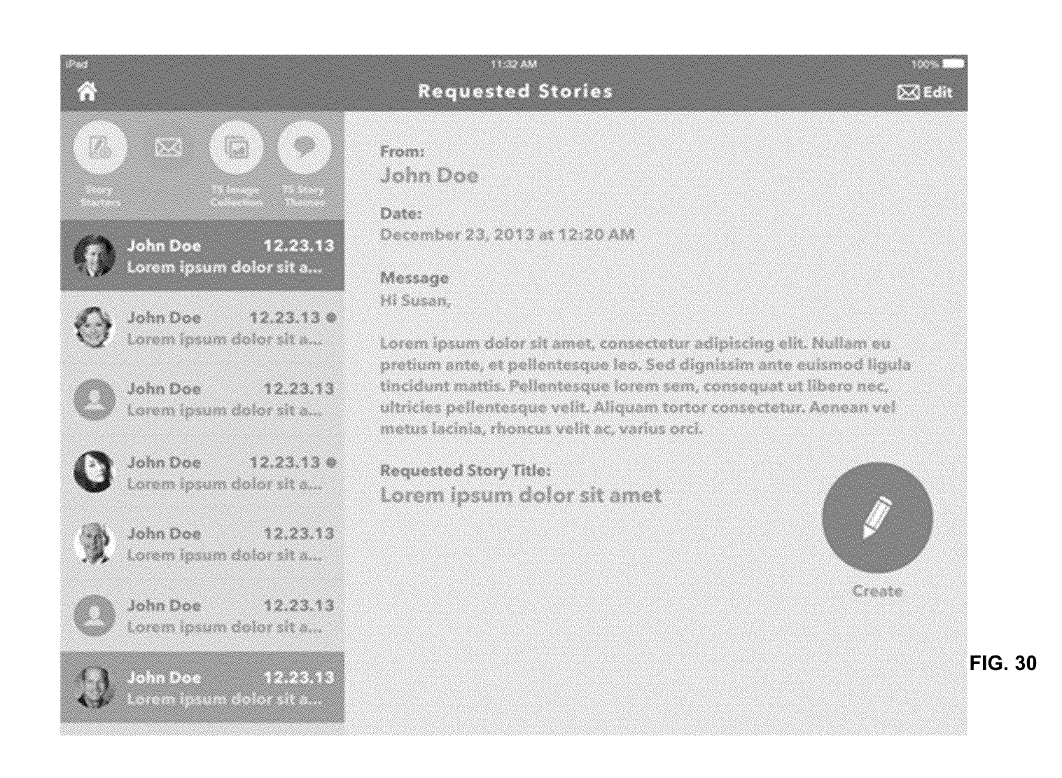

FIG. 30 illustrates an exemplary page that appears when a user selects the “notifications” icon. It can open up a page that shows the user incoming story requests and prompts the user to create that story.

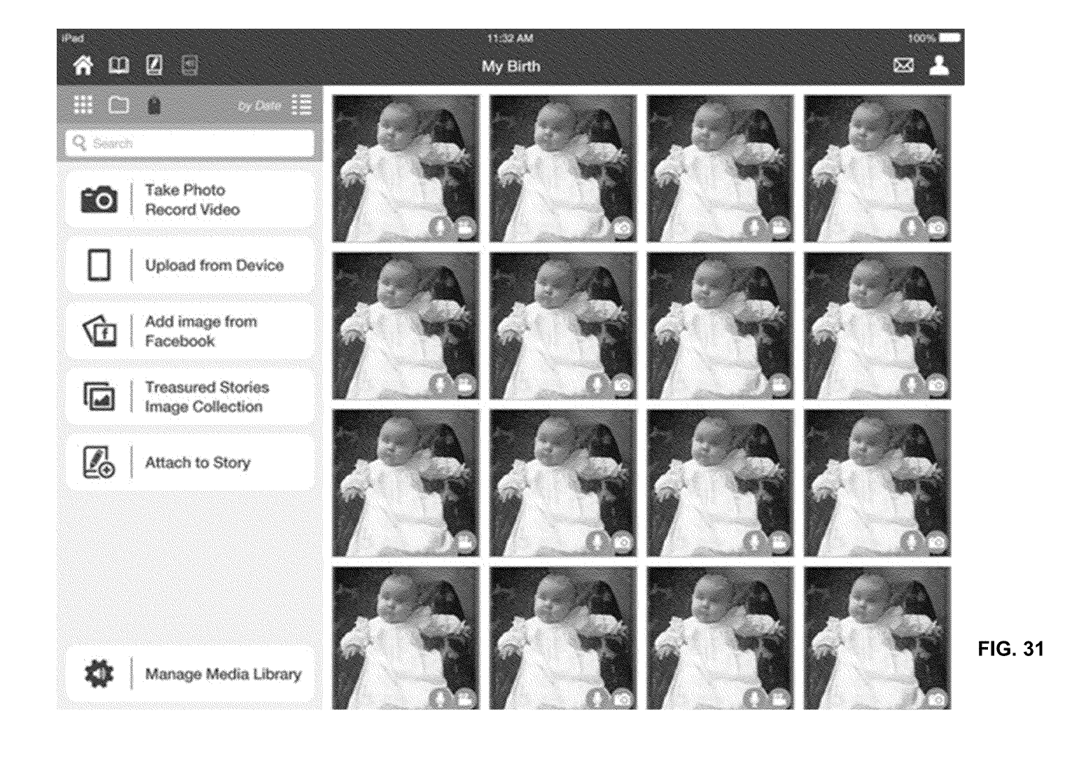

FIG. 31 illustrates an exemplary media library. Users can upload photos into the media library using numerous options including taking a photo at the present time and having it import directly to the media library. Users can select any photo and start recording a narration to attach to the photo.

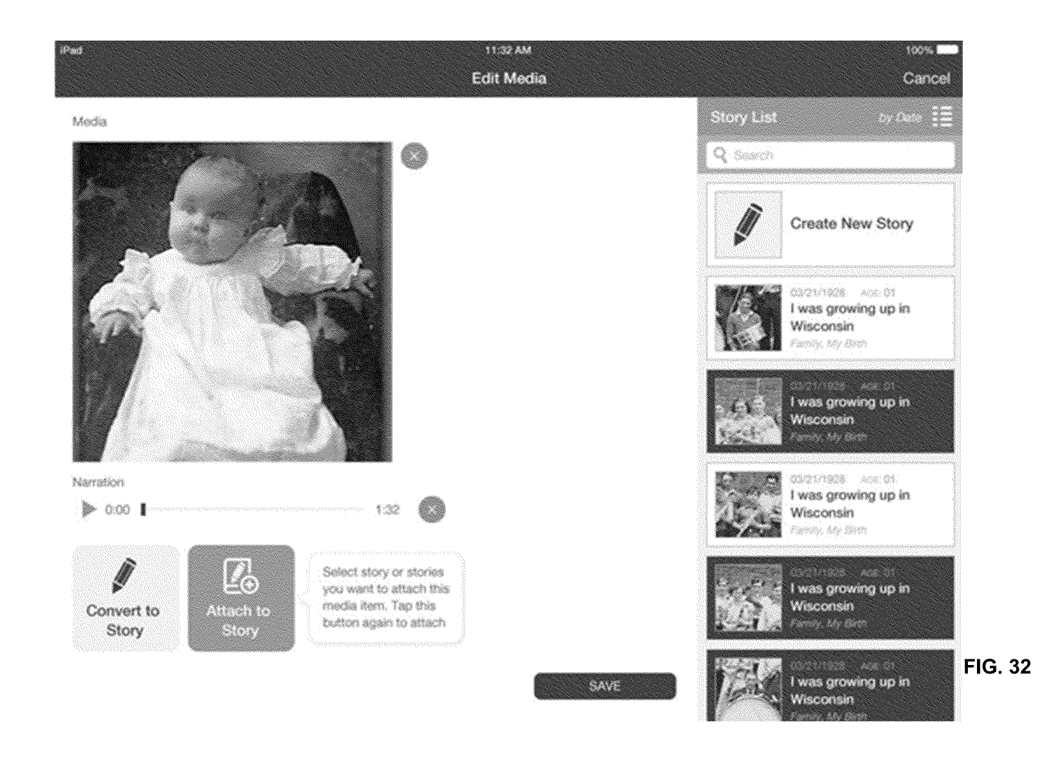

FIG. 32 illustrates an exemplary page that demonstates a media library when a specific photo has been narrated. The specific photo can be converted into its own story or attached to existing stories.

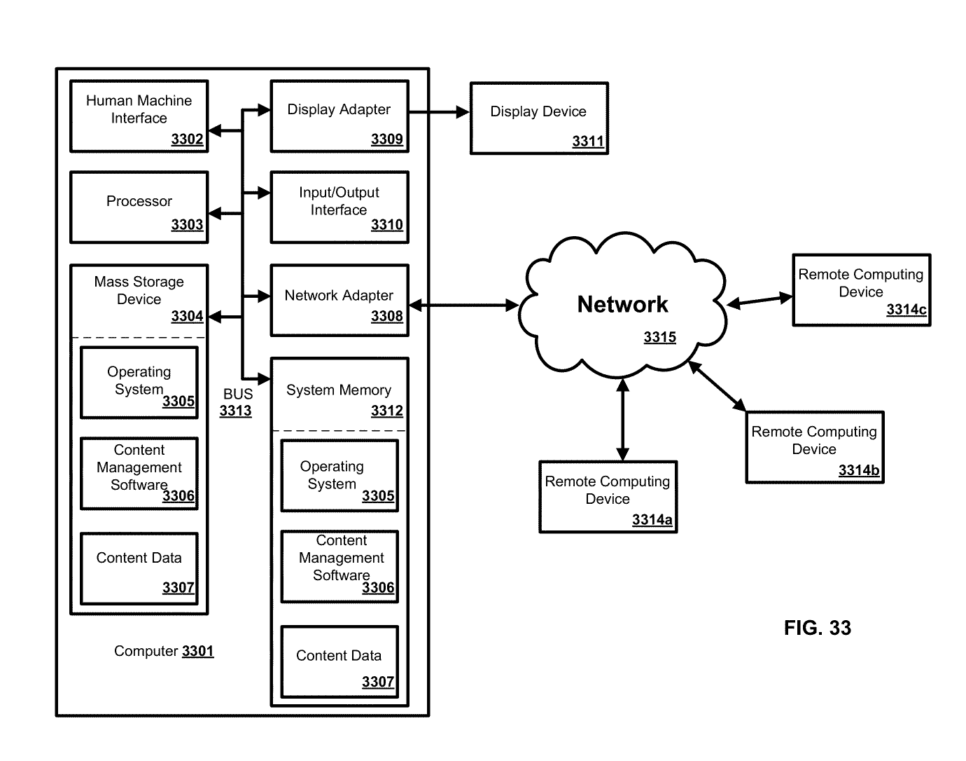

FIG. 33 illustrates an exemplary computer device. As an example, the computing device 3301 can comprise one or more servers as shown in FIG. 1. As another example, computing device 3301 can be a user device, such as a smartphone, a tablet, a computer,

The system has been described above as comprised of units. One skilled in the art will appreciate that this is a functional description and that the respective functions can be performed by software, hardware, or a combination of software and hardware. A unit can be software, hardware, or a combination of software and hardware. The units can comprise the content management Software 3306 as illustrated in FIG. 33 and described below. In one exemplary aspect, the units can comprise a computer 101 as illustrated in FIG. 1 and described below.

FIG. 33 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 3301. The components of the computer 3301 can comprise, but are not limited to, one or more processors or processing units 3303, a system memory 3312, and a system bus 3313 that couples various system components including the processor 3303 to the system memory 3312. In the case of multiple processing units 3303, the system can utilize parallel computing. When the computing device 3301 comprises a server of a content management system, the processing units 3303 can be configured to receiving a plurality of content items, wherein the content the plurality of content items are associated with a theme, processing the received plurality of content items in accordance with at least one view, and transmitting the processed plurality of content items.

The system bus 3313 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 3313, and all buses specified in this description can also be implemented over a wired or wireless network connection and each of the subsystems, including the processor 3303, a mass storage device 3304, an operating system 3305, content management software 3306, content data 3307, a network adapter 3308, system memory 3312, an Input/Output Interface 3310, a display adapter 3309, a display device 3311, and a human machine interface 3302, can be contained within one or more remote computing devices 3314a,b,c at physically separate locations, connected through buses of this form, in effect implementing a fully distributed system.

The computer 3301 typically comprises a variety of computer readable media. Exemplary readable media can be any available media that is accessible by the computer 3301 and comprises, for example and not meant to be limiting, both volatile and non-volatile media, removable and non-removable media. The system memory 3312 comprises computer readable media in the form of volatile memory, such as random access memory (RAM), and/or non-volatile memory, such as read only memory (ROM). The system memory 3312 typically contains data such as content data 3307 and/or program modules such as operating system 3305 and content management software 3306 that are immediately accessible to and/or are presently operated on by the processing unit 3303.

In another aspect, the computer 3301 can also comprise other removable/non-removable, volatile/non-volatile computer storage media. By way of example, FIG. 33 illustrates a mass storage device 3304 which can provide non-volatile storage of computer code, computer readable instructions, data structures, program modules, and other data for the computer 3301. For example and not meant to be limiting, a mass storage device 3304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 3304, including by way of example, an operating system 3305 and content management software 3306. Each of the operating system 3305 and content management software 3306 (or some combination thereof) can comprise elements of the programming and the content management software 3306. Content data 3307 can also be stored on the mass storage device 3304. Content data 3307 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 3301 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 3303 via a human machine interface 3302 that is coupled to the system bus 3313, but can be connected by other interface and bus structures, such as a parallel port, game port, an IEEE 1394 Port (also known as a Firewire port), a serial port, or a universal serial bus (USB).

In yet another aspect, a display device 3311 can also be connected to the system bus 3313 via an interface, such as a display adapter 3309. It is contemplated that the computer 3301 can have more than one display adapter 3309 and the computer 3301 can have more than one display device 3311. For example, a display device can be a monitor, an LCD (Liquid Crystal Display), or a projector. In addition to the display device 3311, other output peripheral devices can comprise components such as speakers (not shown) and a printer (not shown) which can be connected to the computer 3301 via Input/Output Interface 3310. Any step and/or result of the methods can be output in any form to an output device. Such output can be any form of visual representation, including, but not limited to, textual, graphical, animation, audio, tactile, and the like.

The computer 3301 can operate in a networked environment using logical connections to one or more remote computing devices 3314a,b,c. By way of example, a remote computing device can be a personal computer, portable computer, a server, a router, a network computer, a peer device or other common network node, and so on. Logical connections between the computer 3301 and a remote computing device 3314a,b,c can be made via a local area network (LAN) and a general wide area network (WAN). Such network connections can be through a network adapter 3308. A network adapter 3308 can be implemented in both wired and wireless environments. Such networking environments are conventional and commonplace in offices, enterprise-wide computer networks, intranets, and the Internet 3315.

For purposes of illustration, application programs and other executable program components such as the operating system 3305 are illustrated herein as discrete blocks, although it is recognized that such programs and components reside at various times in different storage components of the computing device 3301, and are executed by the data processor(s) of the computer. An implementation of content management software 3306 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

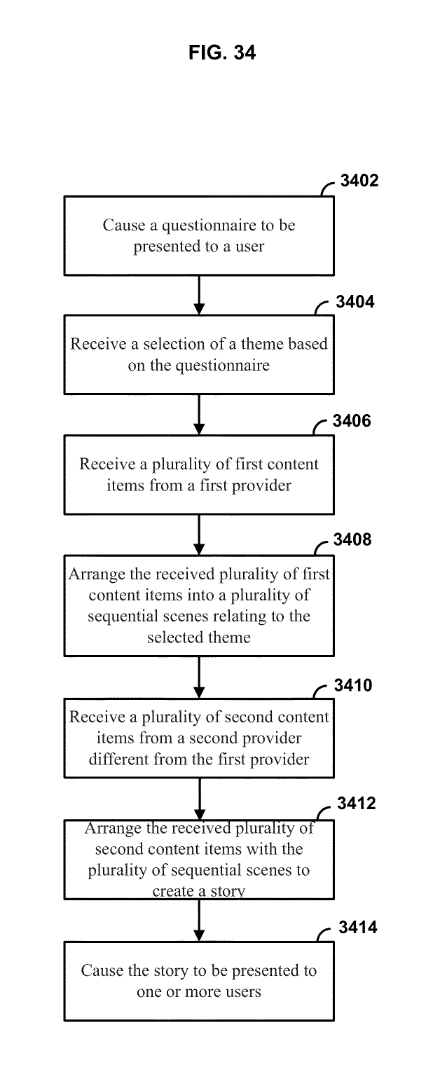

FIG. 34 illustrates an exemplary method. At step 3402, a content management server can cause a questionnaire to be presented to a user. As an example, the content management server can comprise a computing device.

At step 3404, a selection of a theme based on the questionnaire using a computing device can be received. At step 3406, a plurality of first content items can be received from a first provider. The plurality of first content items can be associated with the selected theme. The plurality of first content items can comprise one or more images and one or more narrations.

At step 3408, the computing device can arrange the received plurality of first content items into a plurality of sequential scenes relating to the selected theme using the computing device. In an aspect, one or more sequential scenes of the plurality of sequential scenes can comprise a scene image and a scene narration relating to the scene image. In an aspect, the plurality of first content items can be automatically arranged by the computing device.

At step 3410, a plurality of second content items can be received from a second provider different from the first provider. In an aspect, the plurality of second content items can be associated with the selected theme. In another aspect, the plurality of second content items can comprise one or more images and one or more narrations.

At step 3412, the computing device can arrange the received plurality of second content items with the plurality of sequential scenes to create a story using the computing device. In an aspect, the plurality of second content items can be automatically arranged by the computing device.

At step 3414, the computing device can cause the story to be presented to one or more users. In an aspect, the first provider and the second provider can be authorized to modify the story, while non-authorized providers can be restricted from modifying the story. In another aspect, the first provider and the second provider can be authorized to modify the story, while non-authorized providers can be permitted to access the story but are restricted from modifying the story.

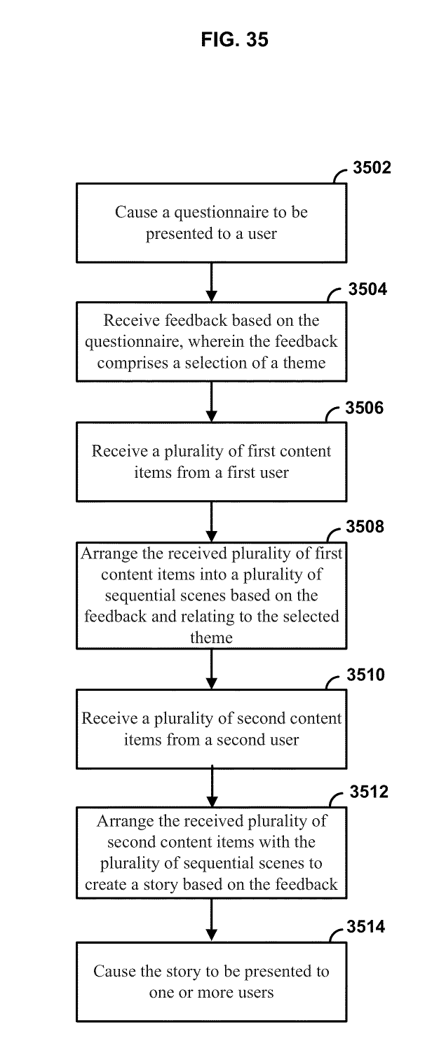

FIG. 35 illustrates an exemplary method. At step 3502, a content management server can cause a questionnaire to be presented to a user. As an example, the content management server can be a computing device.

At step 3504, the content management server (e.g., computing device) can receive feedback, based on the questionnaire. In an aspect, the feedback can comprise a selection of a theme.

At step 3506, the content management server (e.g., computing device) can receive a plurality of first content items from a first user. In an aspect, the plurality of first content items can be associated with the selected theme. In another aspect, the plurality of first content items can comprise one or more images and one or more narrations.

At step 3508, the content management server (e.g., the computing device) can arrange the received plurality of first content items into a plurality of sequential scenes based on the feedback and relating to the selected theme. In an aspect, one or more sequential scenes of the plurality of sequential scenes can comprise a scene image and a scene narration relating to the scene image. In an aspect, the plurality of first content items can be automatically arranged by the computing device.

At step 3510, the content management server (e.g., the computing device) can receive a plurality of second content items from a second user. In an aspect, the plurality of second content items can be associated with the theme. In another aspect, the plurality of second content items can comprise one or more images and one or more narrations. In an aspect, the plurality of second content items can be automatically arranged by the computing device.

At step 3512, the content management server (e.g., the computing device) can arrange the received plurality of second content items with the plurality of sequential scenes to create a story based on the feedback. In an aspect, the first provider and the second provider can be authorized to modify the story, while non-authorized providers are restricted from modifying the story, in another aspect, the first provider and the second provider can be authorized to modify the story, while non-authorized providers can be permitted to access the story but are restricted from modifying the story.

At step 3514, the content management server (e.g., the computing device) can cause the story to be presented to a user.

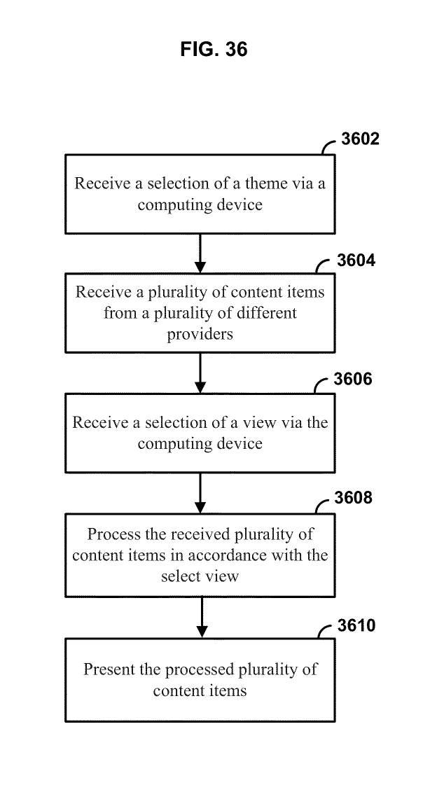

FIG. 36 illustrates an exemplary method. At step 3602, a content management server can receive a selection of a theme. As an example, the content management server can be a computing device. As another example, the theme can be related to a life event.

At step 3604, the content management server (e.g., the computing device) can receive a plurality of content items from a plurality of different providers. In an aspect, the plurality of content items can be associated with the select theme. In an aspect, the plurality of content items can comprise one or more of video content, audio content, text, and metadata. As an example, the audio content can comprise narrations or dialogues. As another example, the video content can comprise video clips or one or more photographs.

At step 3606, the content management server (e.g., the computing device) can receive a selection of a view. As an example, the view can comprise a sequential view, chronological view, plot driven view, or masonry view.

At step 3608, the content management server (e.g., the computing device) can process the received plurality of content items in accordance with the select view. In an aspect, the computing device can process the received plurality of content items comprises by arranging the received plurality of content items into a sequence of scenes representing a story. In an aspect, one or more scenes of the sequence of scenes can comprise an image and an audio narrative. As an example, the sequence of scenes can be arranged according to one or more events in a story. As another example, the sequence of scenes can be arranged according to a character in a story.

At step 3610, the content management server (e.g., the computing device) can present the processed plurality of content items. For example, the computing device can present the processed plurality of content items on a user device, such as a computer, a tablet, a smartphone, and the like.

While the methods and systems have been described in connection with preferred aspects and specific examples, it is not intended that the scope be limited to the particular aspects set forth, as the aspects herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of aspects described in the specification.

It will be apparent to those skilled in the art that various modifications and variations can be made without departing from the scope or spirit. Other aspects will be apparent to those skilled in the art from consideration of the specification and practice disclosed herein. It is intended that the specification and examples be considered as exemplary only, with a true scope and spirit being indicated by the following claims.

What is claimed is:

1. A method for collaborative storytelling based on content received from a plurality of different providers, the method comprising:
causing a questionnaire to be presented to a user;
receiving a selection of a theme based on the questionnaire using a computing device;
receiving a plurality of first content items from a first provider, wherein the plurality of first content items are associated with the selected theme, and wherein the plurality of first content items comprise one or more images and one or more narrations;
arranging, using the computing device, the received plurality of first content items into a plurality of sequential scenes relating the selected theme, wherein one or more sequential scenes of the plurality of sequential scenes comprises a scene image and a scene narration relating to the scene image;
receiving a plurality of second content items from a second provider different from the first provider, wherein the plurality of second content items are associated with the selected theme, and wherein the plurality of second content items comprise one or more images and one or more narrations;
arranging, using the computing device, the received plurality of second content items with the plurality of sequential scenes to create a story; and
causing the story to be presented to one or more users.

2. The method of claim 1, wherein the plurality of first content items and the plurality of second content items are automatically arranged by the computing device.

3. The method of claim 1, wherein the first provider and the second provider are authorized to modify the story, while non-authorized providers are restricted from modifying the story.

4. The method of claim 1, wherein the first provider and the second provider are authorized to modify the story, while non-authorized providers are permitted to access the story but are restricted from modifying the story.

5. A method for preserving personal memories and presenting a collaborative story to one or more users, the method comprising:
causing a questionnaire to be presented to a user;
receiving feedback, via a computing device, based on the questionnaire, wherein the feedback comprises a selection of a theme;
receiving a plurality of first content items from a first user, wherein the plurality of first content items are associated with the selected theme, and wherein the plurality of first content items comprise one or more images and one or more narrations;
arranging, using the computing device, the received plurality of first content items into a plurality of sequential scenes based on the feedback and relating to the selected theme, wherein one or more sequential scenes of the plurality of sequential scenes comprises a scene image and a scene narration relating to the scene image;
receiving a plurality of second content items from a second user, wherein the plurality of second content items are associated with the theme, and wherein the plurality of second content items comprise one or more images and one or more narrations;
arranging, using the computing device, the received plurality of second content items with the plurality of sequential scenes to create a story based on the feedback; and
causing the story to be presented to a user.

6. The method of claim 5, wherein the plurality of first content items and the plurality of second content items are automatically arranged by the computing device.

7. The method of claim 5, wherein the first provider and the second provider are authorized to modify the story, while non-authorized providers are restricted from modifying the story.

8. The method of claim 5, wherein the first provider and the second provider are authorized to modify the story, while non-authorized providers are permitted to access the story but are restricted from modifying the story.

9. A method for preserving personal memories and generating a collaborative story based on content received by a plurality of different providers, the method comprising:
receiving a selection of a theme via a computing device;
receiving a plurality of content items from a plurality of different providers, wherein the plurality of content items are associated with the select theme;
receiving a selection of a view via the computing device;
processing the received plurality of content items in accordance with the select view, wherein the processing the received plurality of content items comprises arranging the received plurality of content items into a sequence of scenes representing a story, and wherein one or more scenes of the sequence of scenes comprises an image and an audio narrative; and
presenting the processed plurality of content items.

10. The method of claim 9, wherein the theme is related to a life event.

11. The method of claim 9, wherein the plurality of content items comprises one or more of video content, audio content, text, and metadata.

12. The method of claim 11, wherein the audio content comprises narrations or dialogues.

13. The method of claim 11, wherein the video content comprises video clips or one or more photographs.

14. The method of claim 9, wherein the view comprises a sequential view, chronological view, plot driven view, or masonry view.

15. The method of claim 9, wherein the sequence of scenes is arranged according to one or more events in a story.

16. The method of claim 9, wherein the sequence of scenes is arranged according to a character in a story.
